(19) United States
(12) Patent Application Publication
(10) Pub. No.: US 2016/0246293 A1
(43) Pub. Date: Aug. 25, 2016

(54) COMPUTER-READABLE RECORDING MEDIUM HAVING RECORDED THEREIN COMPONENT ARRANGEMENT PROGRAM, METHOD OF ARRANGING COMPONENTS, AND INFORMATION PROCESSING APPARATUS

(71) Applicant: FUJITSU LIMITED, Kawasaki-shi (JP)

(72) Inventors: Kazuhiro Sakai, Kawasaki (JP); Masato Ariyama, Kawasaki (JP); AKIRA MIMURA, Kawasaki (JP); Yusuke Kimura, Kawasaki (JP)

(73) Assignee: FUJITSU LIMITED, Kawasaki-shi (JP)

(21) Appl. No.: 14/988,805

(22) Filed: Jan. 6, 2016

(30) Foreign Application Priority Data
Feb. 20, 2015 (JP) 2015-031858

(51) Int. Cl. G05B 19/418

(52) U.S. Cl. CPC G05B 19/41835; G05B 2219/45031; G05B 2219/31029

(57) ABSTRACT

In the present case, when one component of a plurality of components is arranged, an interference state between a first check region set to the one component and a second check region set to an arranged component near the one component. If the checked interference state satisfies predetermined conditions, an arrangement position of the one component is determined by permitting the interference state. Then, the first check region and the second check region are combined and the combined check region is used as one check region set to the one component and the arranged component. Accordingly, the arrangement position of a component to be arranged can be determined by considering arrangements of a plurality of components therearound on a board.

### CROSS-REFERENCE TO RELATED APPLICATION

This application is based upon and claims the benefit of priority of the prior Japanese Patent application No. 2015-31858, filed on Feb. 20, 2015, the entire contents of which are incorporated herein by reference.

### FIELD

The present invention relates to a computer-readable recording medium having recorded therein a component arrangement program, a method of arranging components, and an information processing apparatus.

### BACKGROUND

Various electronic devices contain a board (hereinafter, may be called a printed board) such as a printed wiring board. When various electronic devices are designed, the arrangement of a plurality of components to be mounted on a printed board is designed. To support the determination of arrangement position of each component while designing the arrangement, interactive CAD (Computer Aided Design) technologies have been proposed (see, for example, JP H5-314217 A and JP H8-227428 A).

In the CAD technologies, for example, one component is selected from a plurality of components as a component to be arranged and a step of arranging the selected component to be arranged is repeatedly executed until all components are arranged on the board. Then, the arrangement position of each component is determined based on network connection information between the plurality of components. Information about the arrangement positions of components whose arrangement positions on the board have been determined is stored in an obstacle management table.

Hereinafter, when the arrangement position of a component to be arranged is determined, the obstacle management table is referred to each time a user (a designer or the like) arranges a component to be arranged in a desired position. Then, an interference check whether an occupation region of a component whose arrangement position has been determined and an occupation region of the component to be arranged interfere is done. If interference occurs, it is determined that the component to be arranged cannot be arranged in the desired position and the user is notified of an error. On the other hand, if no error occurs, it is determined that the component to be arranged can be arranged in the desired position and the desired position can be determined as the arrangement position of the component to be arranged.

In the above interference check, whether the component to be arranged and a component whose arrangement position has been determined and positioned near the component to be arranged interfere physically is checked. Instead of such an interference check, a check whether a gap of a predetermined interval can be secured between an occupation region of the component to be arranged and an occupation region of a component whose arrangement position has been determined and positioned near the component to be arranged may be done.

When an interference check as described above is done, as will be described below, there are some cases when it is desirable to consider, in addition to a one-to-one relationship between the component to be arranged and a component nearby, a plurality of components near the component to be arranged together.

When, for example, components with large heat capacities or heavy components are arranged nearby in a one-to-one relationship, even if a problem of heating of components or a problem of deformation of the board due to the weight of components should not arise as long as a certain interval is secured between the two components, the influence of the above problems may increase with an increasing number of components arranged nearby. In such a case, for example, a required minimum interval b (see FIG. 31B) between components when three components are arranged nearby is preferably set larger than a required minimum interval a (see FIG. 31A) between components when two components are arranged nearby.

Therefore, to mount components in a high density on a board without causing problems of heating and weights, it is preferable to determine the arrangement position of the component to be arranged while comprehensively considering a plurality of arranged components present near the component to be arranged. In the current technology, however, only an interference check based on occupation regions of the component to be arranged and each arranged component nearby is done in a one-to-one relationship and it is difficult to determine the arrangement position of the component to be arranged by comprehensively considering a plurality of arranged components present near the component to be arranged.

### SUMMARY

A component arrangement program in the present case is a program that causes a computer to perform processing to arrange a plurality of components on a board and causes the computer to perform processes (1) to (3) below:

(1) checking, when arranging one component of the plurality of components, an interference state between a first check region set to the one component and a second check region set to an arranged component near the one component;

(2) determining, when the interference state checked satisfies predetermined conditions, a position where the one component is arranged, while permitting the interference state; and

(3) combining the first check region and the second check region to use a combined check region as one check region set for the one component and the arranged component.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1 is a block diagram showing an example of a function configuration of an information processing apparatus having a component arrangement function as an embodiment of the present invention;

FIG. 2 is a block diagram showing an example of a hardware configuration of the information processing apparatus having the component arrangement function as an embodiment of the present invention;

FIG. 3 is a diagram showing an example of a component attribute library in the present embodiment;

FIG. 4 is a diagram showing an example of a component shape library in the present embodiment;

FIG. 5 is a diagram illustrating a plurality of interference check regions set to each component in the present embodiment;

FIG. 6 is a diagram showing an example of permitted values set to each interference check regions when a predetermined attribute is a heating value;

FIG. 7 is a diagram showing an example of permitted values set to each interference check regions when a predetermined attribute is a weight;

FIG. 8 is a diagram showing an example of permitted values set to each interference check regions when a predetermined attribute is an electromagnetic field;

FIG. 9 is a flow chart illustrating an example of an operation (determination procedure of an arrangement position of a component to be arranged) of the information processing apparatus having the component arrangement function shown in FIGS. 1 and 2;

FIGS. 10 to 12 are diagrams illustrating a first example of a concrete arrangement position determination procedure of the component to be arranged according to the present embodiment;

FIGS. 13 to 15 are diagrams illustrating a second example of the concrete arrangement position determination procedure of the component to be arranged according to the present embodiment;

FIGS. 16 to 18 are diagrams illustrating a third example of the concrete arrangement position determination procedure of the component to be arranged according to the present embodiment;

FIGS. 19 to 21 are diagrams illustrating a fourth example of the concrete arrangement position determination procedure of the component to be arranged according to the present embodiment;

FIG. 22 is a diagram illustrating a fifth example of the concrete arrangement position determination procedure of the component to be arranged according to the present embodiment;

FIGS. 23 to 28 are diagrams illustrating an example of an arrangement operation and a rats nest display when a user determines the arrangement position of the component to be arranged;

FIG. 29 is a flow chart illustrating an example of the arrangement position determination procedure of the component to be arranged performed by using a rats nest display technology shown in FIGS. 23 to 28;

FIG. 30 is a diagram providing an overview of the present embodiment; and

FIG. 31A is a diagram showing a required minimum interval between components when two components are arranged nearby and FIG. 31B is a diagram showing a required minimum interval between components when three components are arranged nearby.

### DESCRIPTION OF THE PREFERRED EMBODIMENTS

Hereinafter, an embodiment of a computer-readable recording medium having recorded therein a component arrangement program, a method of arranging components, and an information processing apparatus disclosed by the present application will be described in detail with reference to the drawings. However, the embodiment shown below is by way of example and there is no intention to exclude various modifications and application of technology that are not explicitly shown in the embodiment. That is, the present embodiment can be carried out by making various modifications without deviating from the spirit thereof. Each diagram is not intended to include only elements shown in the diagram and may include other functions. Then, each embodiment can appropriately be combined within a range in which no contradiction of processing content is incurred.

### [1] Related Technology of the Present Embodiment

### [1-1] Rats Nest Display

The user (designer or the like) determines the arrangement position of a component to be arranged on a board (ex. substrate) based on network connection information. In this case, a network connection (rats nest) of pins of the component to be arranged and pins of other components connected to the pins is displayed in a display unit based on the network connection information. The user arranges the component to be arranged in an appropriate position by, for example, a drag & drop operation of the mouse while grasping a connecting relationship of pins of the component to be arranged and pins of other components by referring to rats nest displayed in the display unit.

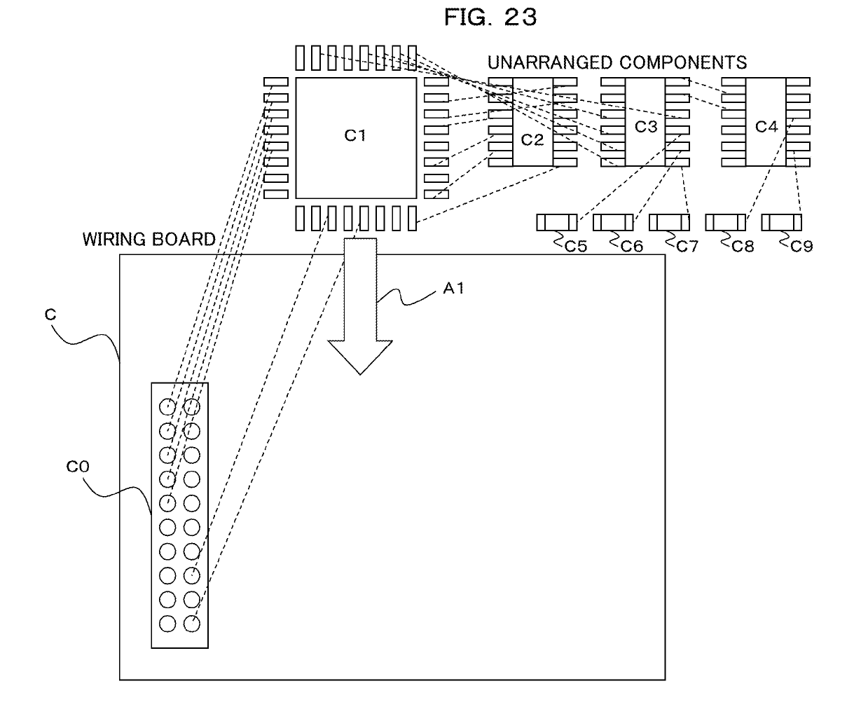

Here, an example of an arrangement operation and a rats nest display when a user determines the arrangement position of the component to be arranged will be described with reference to FIGS. 23 to 28.

In FIG. 23, a display state when the arrangement of components is started is displayed. In FIG. 23, a wiring board (wiring substrate) C and components C1 to C9 to be arranged on the wiring board C are displayed. At this point, only a connector C0 is arranged on the wiring board C and the components C1 to C9 are arranged in a display region of unarranged components outside the wiring board C. In addition, the connecting relationship of each terminal of the connector C0 and each pin of the component C1 and the connecting relationships between pins of the components C1 to C9 are displayed, as illustrated by a dotted line, as rats nest.

Here, each of the components C1 to C4 is an active component and the component C1 is, for example, a QFP (Quad Flat Package) or a QFJ (Quad Flat J-leaded) package and each of the components C2 to C4 is, for example, an SOP (Small Outline Package) or an SOJ (Small Outline J-leaded) package. Each of the components C5 to C9 is a passive components and is, for example, a connector of a mechanism component, a 2-terminal chip capacitor, or a resistor. Each of the components C1 to C9 may be a BGA (Ball Grid Array) package or an IMD (Insertion Mount Device) or SMD (Surface Mount Device).

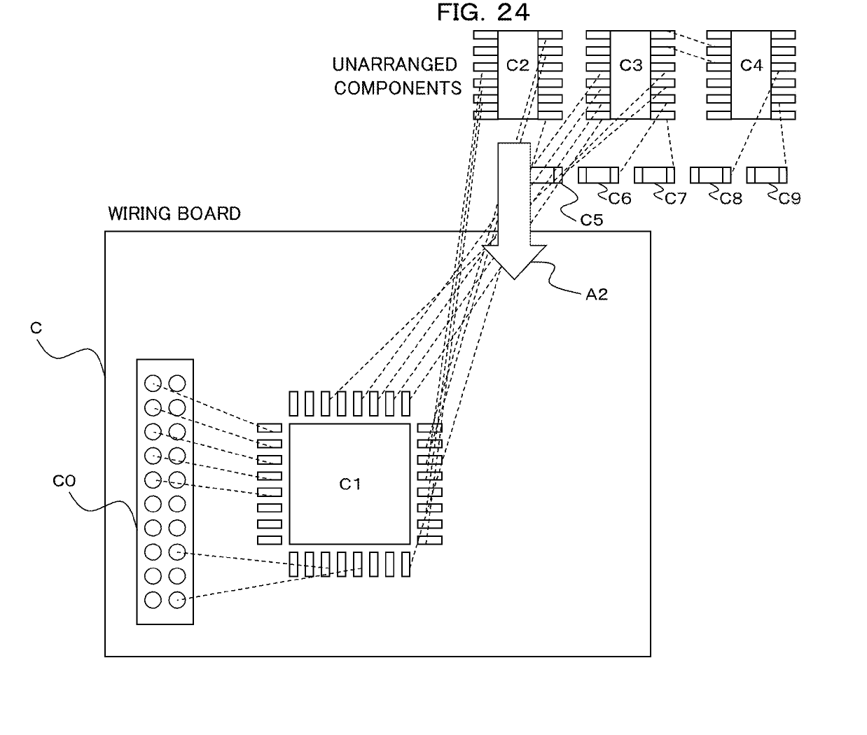

First, in the display shown in FIG. 23, the user selects the component C1 as the component to be arranged and moves the component in the direction of an arrow A1 by a mouse operation to arrange, as shown in FIG. 24, the component C1 on the wiring board C. The connection relationships of the connector C0 and the components C1 to C9 are displayed as rats nest during movement and after arrangement of the component C1 (see dotted lines in FIG. 24).

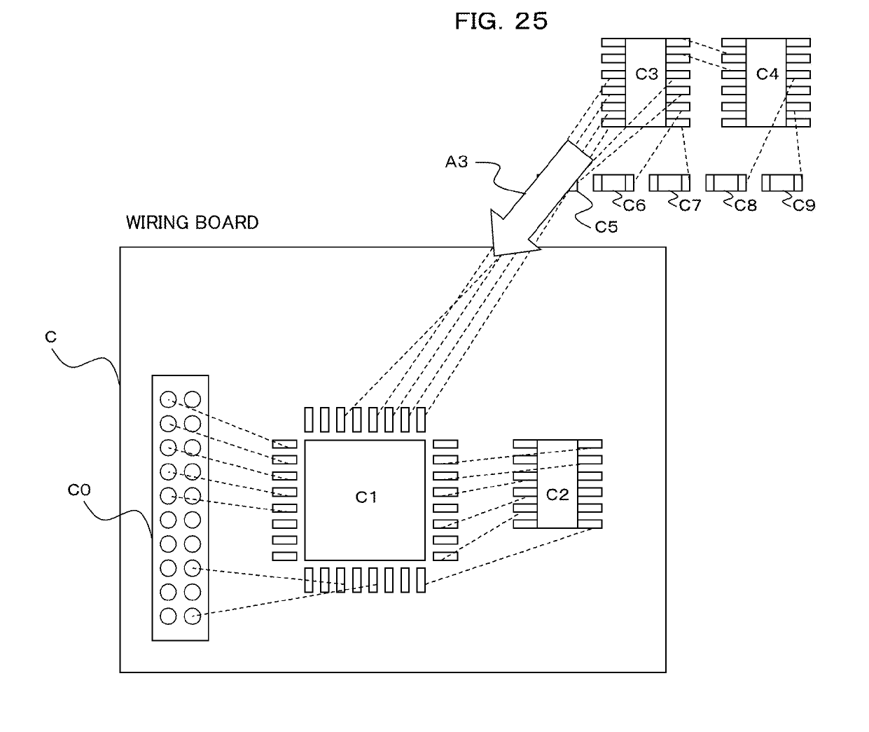

Next, in the display shown in FIG. 24, the user selects the component C2 as the component to be arranged and moves the component in the direction of an arrow A2 by a mouse operation to arrange, as shown in FIG. 25, the component C2 on the wiring board C. The connection relationships of the connector C0 and the components C1 to C9 are displayed as rats nest during movement and after arrangement of the component C2 (see dotted lines in FIG. 25).

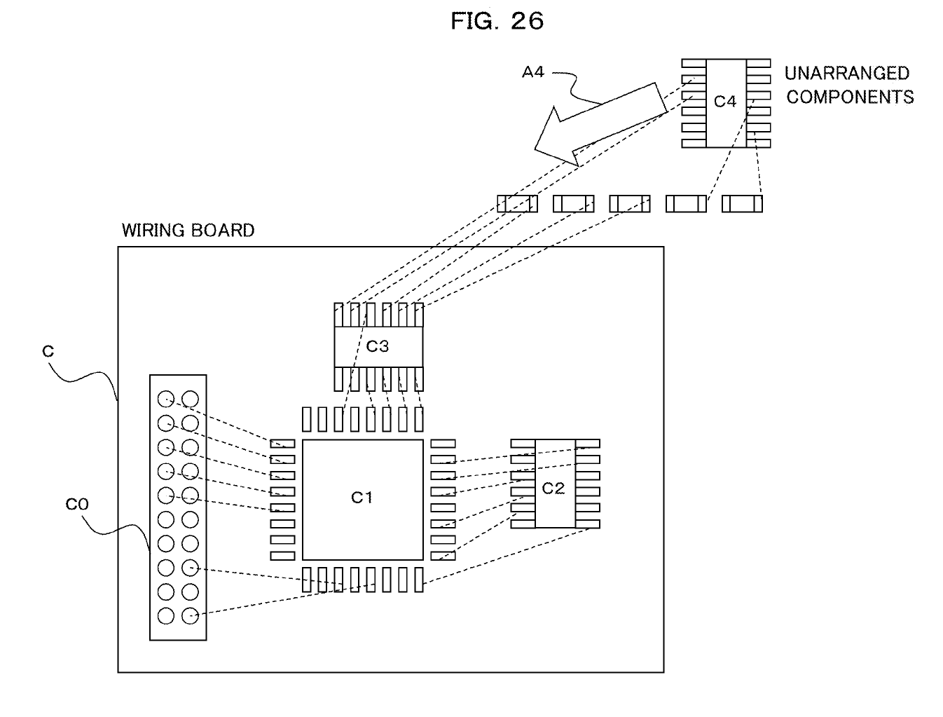

Also, in the display shown in FIG. 25, the user selects the component C3 as the component to be arranged and moves the component in the direction of an arrow A3 by a mouse operation to arrange, as shown in FIG. 26, the component C3 on the wiring board C. The connection relationships of the connector C0 and the components C1 to C9 are displayed as rats nest during movement and after arrangement of the component C3 (see dotted lines in FIG. 26).

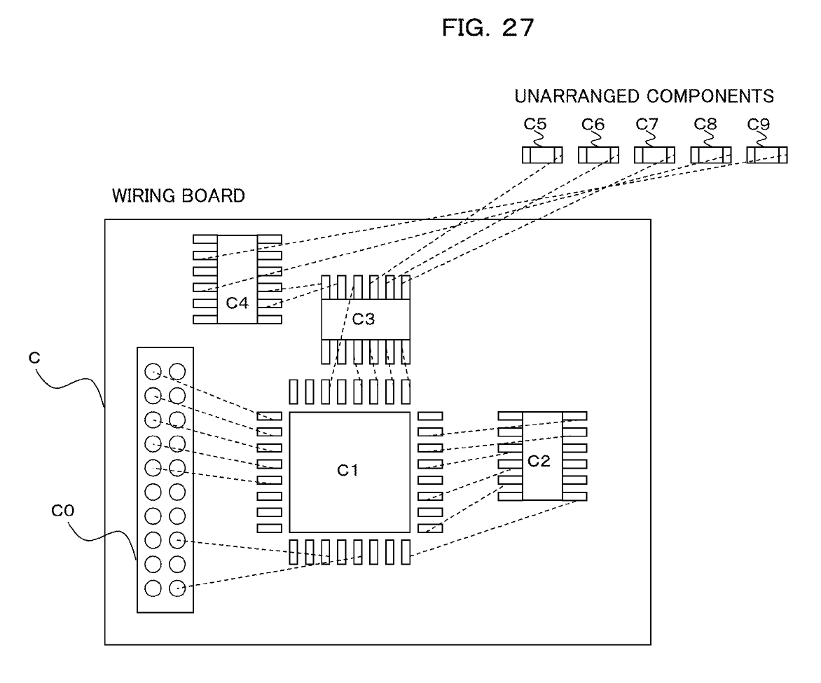

Further, in the display shown in FIG. 26, the user selects the component C4 as the component to be arranged and moves the component in the direction of an arrow A4 by a mouse operation to arrange, as shown in FIG. 27, the component C4 on the wiring board C. The connection relationships of the connector C0 and the components C1 to C9 are displayed as rats nest during movement and after arrangement of the component C4 (see dotted lines in FIG. 27).

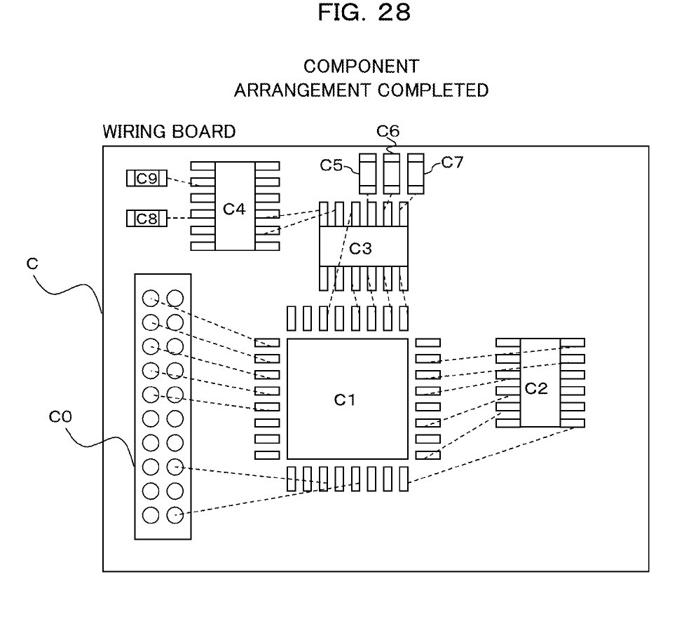

Similarly, in the display shown in FIG. 27, the user selects one component of each of the components C5 to C9 and moves the components by a mouse operation to arrange, as shown in FIG. 28, the components C5 to C9 on the wiring board C. The connection relationships of the connector C0 and the components C1 to C9 are displayed as rats nest during movement and after arrangement of the components C5 to C9 (see dotted lines in FIG. 28).

In this manner, the user can appropriately arrange the components C1 to C9 on the wiring board C by grasping the connection relationships of the connector C0 and the components C1 to C9 with reference to the rats nest display.

### [1-2] Related Technology Contrasted with the Present Embodiment

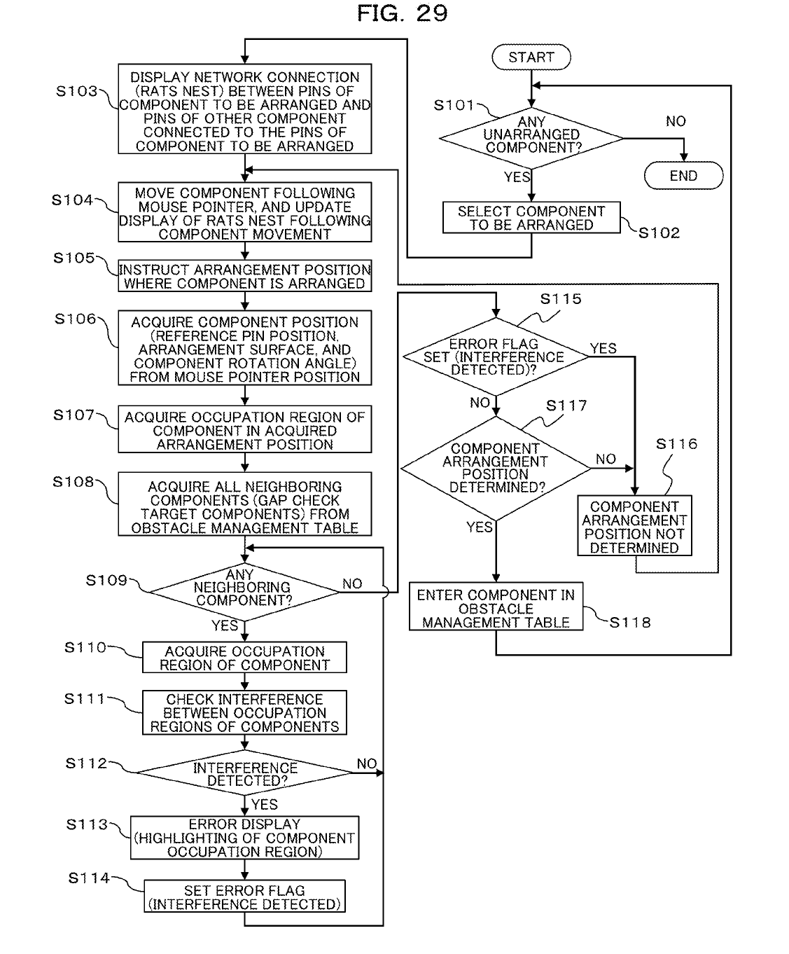

Next, an example of the determination procedure of the arrangement position of a component to be arranged performed using the rats nest display technology described above with reference to FIGS. 23 to 28 will be described following the flow chart (steps S101 to S118) shown in FIG. 29. Here, the determination procedure of the arrangement position of the component to be arranged following the flow chart shown in FIG. 29 is performed using an information processing apparatus such as a PC (Personal Computer).

First, the information processing apparatus determines whether there is any unarranged component (step S101) and if there is no unarranged component (NO route in step S101), the process is terminated. On the other hand, if there is an unarranged component (YES route in step S101), the component to be arranged is selected and moved in accordance with a mouse operation by the user (step S102).

At this point, as shown in FIGS. 23 to 28, a network connection (rats nest) of pins of the component to be arranged and pins of other components connected to the pins is displayed in a display unit based on network connection information (step S103). Then, the information processing apparatus moves the component to be arranged following a mouse pointer and also updates the display state of the rats nest following the movement of the component to be arranged (step S104).

Then, the user moves the component to be arranged to a desired position on the board by a mouse operation and instructs the arrangement position (step S105). When an instruction of the arrangement position is received, the information processing apparatus acquires the arrangement position (such as the reference pin position, arrangement surface, and component rotation angle) of the component to be arranged based on the position of the mouse pointer (step S106). Then, the information processing apparatus acquires an occupation region of the component to be arranged in the acquired arrangement position (step S107) and also acquires all neighboring components (gap check target components) near the component to be arranged from the obstacle arrangement table (step S108).

Next, the information processing apparatus determines whether there is any neighboring component (step S109) and if there is an unprocessed neighboring component (YES route in step S109), selects one neighboring component. Then, the information processing apparatus acquires the occupation region of the component to be arranged and the occupation region of the selected one neighboring component (step S110) and checks whether interference occurs between these occupation regions (steps S111, S112). In the interference check, whether the component to be arranged and an arranged neighboring component interfere physically may be checked or whether a gap of a predetermined interval can be secured between the occupation region of the component to be arranged and the occupation region of an arranged neighboring component may be checked.

If, as a result of the interference check, the component to be arranged and the one neighboring component do not interfere (NO route in step S112), the information processing apparatus returns to the process of step S109. On the other hand, if the component to be arranged and the one neighboring component interfere (YES route in step S112), the information processing apparatus displays an error of the component to be arranged or the one neighboring component (step S113). The display of an error is made by, for example, highlighting the component to be arranged or the one neighboring component. Then, the information processing apparatus sets an error flag (interference) indicating that the component to be arranged and the one neighboring component interfere (step S114) before returning to the process of step S109.

If it is determined in step S109 that there is no unprocessed neighboring component (NO route in step S109), the information processing apparatus determines whether at least one error flag (interference) is set (step S115). If at least one error flag (interference) is set (YES route in step S115), the information processing apparatus determines that an interference state arises with a neighboring component in the position where the component to be arranged is arranged this time and leaves the component arrangement position undetermined (step S116). Then, the information processing apparatus returns to the process of step S104 to continue the movement of the component to be arranged through a mouse operation of the user.

On the other hand, if no error flag (interference) is set (NO route in step S115), the information processing apparatus determines that an interference state does not arise with a neighboring component in the position where the component to be arranged is arranged this time and determines whether to confirm the arrangement position this time as the arrangement position of the component to be arranged (step S117). If a determination instruction is received from a mouse operation of the user or the like, the information processing apparatus determines that the arrangement position this time is confirmed as the arrangement position of the component to be arranged (YES route in step S117) and enters information about the component to be arranged this time in the obstacle management table (step S118). Then, the information processing apparatus returns to the process of step S101.

If no determination instruction is received from the user or an instruction not to determine is received from a mouse operation of the user or the like, the information processing apparatus determines that the arrangement position this time is not determined as the arrangement position of the component to be arranged (NO route in step S117). Then, the information processing apparatus leaves the component arrangement position undetermined (step S116) and returns to the process of step S104 to continue the movement of the component to be arranged through a mouse operation of the user.

### [2] Overview of the Present Embodiment

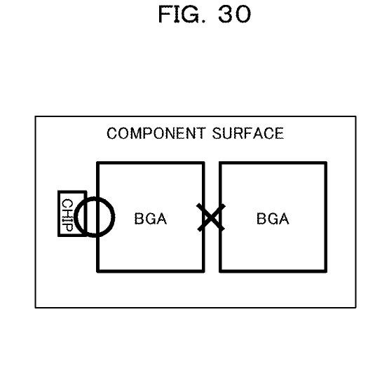

Incidentally, for example, LSIs (Large Scale Integration) in a BGA package shape of a large heat capacity may not be arranged nearby due to a problem of heat generation (heat capacity) as an apparatus (see X on the right side of FIG. 30). However, if the component to be arranged near the LSI in a BGA package shape is a component (chip component) in a chip component package shape such as a resistor or a capacitor, the component may be arranged directly close to the LSI in a BGA package shape (see O on the left side of FIG. 30). The arrangement of components taking a problem of heat generation into consideration cannot be realized based on an interference check simply done based on the occupation region of each component. Thus, it is preferable to determine whether to arrange the component to be arranged by taking the type of the package shape of the component to be arranged and arranged components nearby into consideration.

However, whether another component can be arranged near an arranged component is preferably determined by considering not only the aforementioned problem of heat generation, but also various problems described below. Various problems include, for example, a problem of insufficient solder melting by reflow soldering in a board assembly and manufacturing process, a problem of deformation of the board due to a heavy component, and a problem of influence by an electromagnetic field of a component.

Particularly when various problems described above are considered, as described above, there are some cases when it is preferable to consider, in addition to a one-to-one relationship between the component to be arranged and a component nearby, a plurality of components near the component to be arranged together.

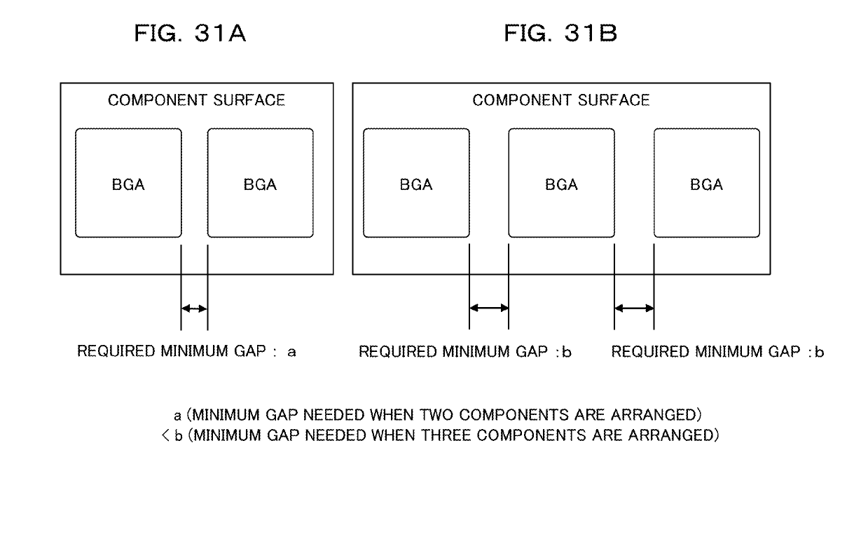

When, for example, components with large heat capacities or heavy components are arranged nearby in a one-to-one relationship, even if the above problems should not arise as long as a certain interval is secured between the two components, the influence of the above problems may increase with an increasing number of components arranged nearby. In such a case, as described above with reference to FIGS. 31A and 31B, for example, the required minimum interval “b” between components when three components are arranged nearby is preferably set larger than the required minimum interval “a” between components when two components are arranged nearby.

Thus, even if whether to arrange the component to be arranged is determined by simply taking information such as the type of the package shape of each component into consideration, it is difficult to do interference checks to solve various problems described above. Therefore, to mount components in a high density on a board without causing various problems described above, it is preferable to determine the arrangement position of the component to be arranged while comprehensively considering a plurality of arranged components present near the component to be arranged and managing the interval between the component to be arranged and the plurality of arranged components present nearby.

In the current state of technology, however, only the interference check between the component to be arranged and each arranged component nearby based on occupation regions is done in a one-to-one relationship. Thus, as described above, it is difficult to determine the arrangement position of the component to be arranged by comprehensively considering a plurality of arranged components present near the component to be arranged.

In the present embodiment, when one component (component to be arranged) among a plurality of components is arranged on a board, an interference state between a first check region set to the one component and a second check region set to an arranged component near the one component is checked. More specifically, whether the interference state satisfies predetermined conditions described below is determined. If the interference state satisfies predetermined conditions, the interference state is permitted, the arrangement position of the one component is determined, and the first check region and the second check region are combined. Then, the combined check region is used as one check region set to one component and an arranged component.

In this case, for example, the following three points (a1) to (a3) may be to be satisfied:

(a1) a same permitted value, which permits the interference state, being set to a predetermined attribute (a heating value, a weight, an electromagnetic field and the like) for each of the first check region and the second check region;

(a2) the first check region and the second check region interfering with each other; and

(a3) a total value of a first attribute value related to the predetermined attribute of the one component and a second attribute value related to the predetermined attribute of the arranged component being equal to or less than the same permitted value.

Also, the following three points (b1) to (b3) may be to be satisfied:

(b1) a same permitted value, which permits the interference state, being set to a predetermined attribute for each of the first check region and the second check region;

(b2) the first check region or the second check region and a first occupation region occupied by the one component or a second occupation region occupied by the arranged component interfering with each other; and

(b3) a total value of a first attribute value related to the predetermined attribute of the one component and a second attribute value related to the predetermined attribute of the arranged component being equal to or less than the same permitted value.

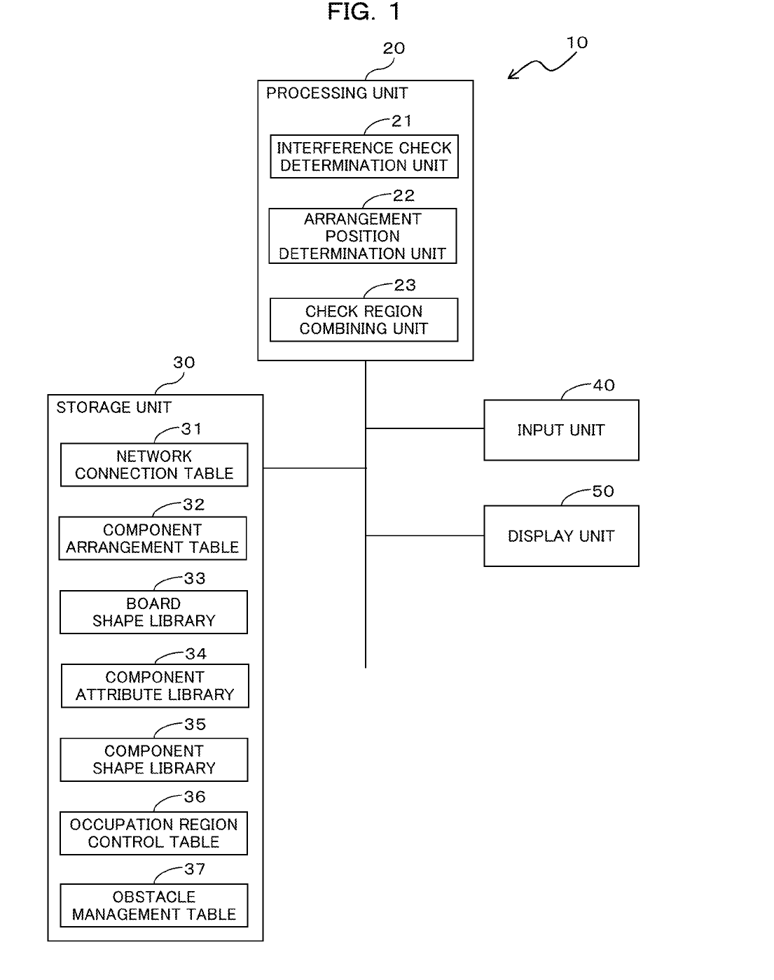

In the present embodiment, for example, libraries (reference numerals 34, 35 in FIGS. 1, 3, and 4) in which an attribute value is set for each element (attribute: heating value, weight, electromagnetic field) of each component and a permitted value of the element is set for each check region set to each component are prepared. Then, an interference check between the check region of the component to be arranged and the check region of a component near the component to be arranged is done.

In the interference check, if, for example, the same permitted value is set to the same element for two check regions interfering with each other, whether the total value of attribute values concerning the relevant element of two components is equal to or less than the same permitted value. If the total value exceeds the permitted value, the predetermined conditions are not satisfied and an interference error is determined to have occurred. On the other hand, if the total value is equal to or less than the permitted value, the predetermined conditions are determined to be satisfied and the arrangement position of the component to be arranged is determined.

Then, the two check regions are combined and the new combined check region is used as one check region (combined check region) set for two components. Hereinafter, if a combined check region is present near a new component to be arranged, an interference check between the check region of the new component to be arranged and the combined check region combined as described above is done in the same manner as described above. Then, information about the result of the interference check done as described above is displayed in the display unit.

### [3] Hardware Configuration of the Information Processing Apparatus Realizing the Component Arrangement Function in the Present Embodiment

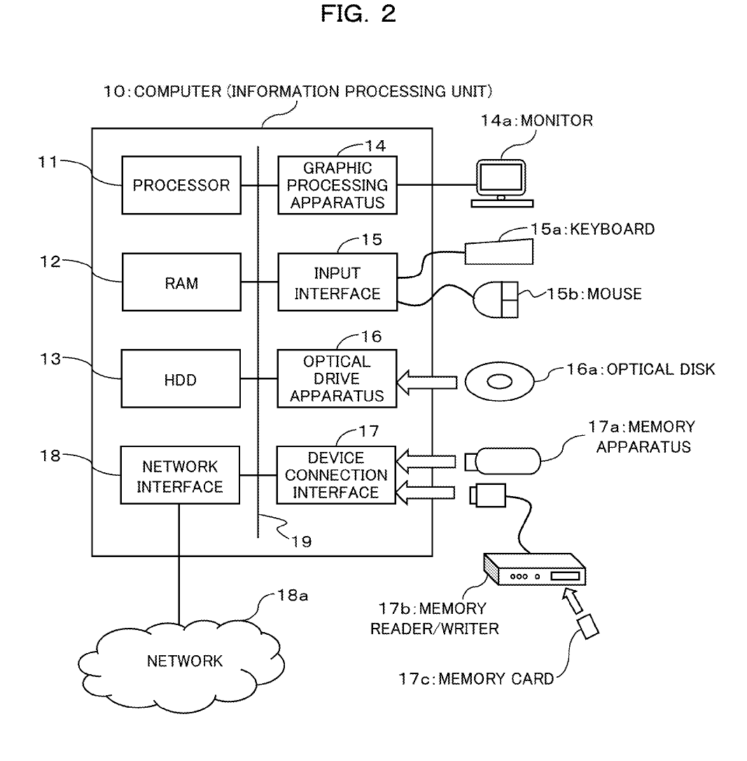

First, the hardware configuration of an information processing apparatus (computer) 10 realizing the component arrangement function in the present embodiment will be described with reference to FIG. 2. FIG. 2 is a block diagram showing an example of the hardware configuration.

The computer 10 includes a processor 11, a RAM (Random Access Memory) 12, an HDD (Hard Disk Drive) 13, a graphic processing apparatus 14, an input interface 15, an optical drive apparatus 16, a device connection interface 17, and a network interface 18 as structural elements. These structural elements 11 to 18 are configured to be mutually communicable via a bus 19.

The processor (processing unit) 11 controls the computer 10 as a whole. The processor 11 may be a multi-processor. The processor 11 may be, for example, any one of CPU (Central Processing Unit), MPU (Micro Processing Unit), DSP (Digital Signal Processor), ASIC (Application Specific Integrated Circuit), PLD (Programmable Logic Device), and FPGA (Field Programmable Gate Array). The processor 11 may also be any combination of two elements of more of CPU, MPU, DSP, ASIC, PLD, and FPGA.

The RAM (storage unit) 12 is used as a main storage device of the computer 10. In the RAM 12, at least a portion of the OS (Operating System) program and application programs the processor 11 is caused to execute is temporarily stored. Also, various kinds of data needed for processing by the processor 11 is stored in the RAM 12. Application programs may include a component arrangement program executed by the processor 11 to realize a model creation function in the present embodiment by the computer 10.

The HDD (storage unit) 13 magnetically writes data to or read data from disks contained. The HDD 13 is used as an auxiliary storage device of the computer 10. In the HDD 13, the OS program, application programs, and various kinds of data are stored. As an auxiliary storage device, a semiconductor storage device (SSD: Solid State Drive) such as a flash memory may also be used.

A monitor 14a is connected to the graphic processing apparatus 14. The graphic processing apparatus 14 causes the monitor 14a to display an image on the screen according to instructions from the processor 11. As the monitor 14a, a display apparatus using CRT (Cathode Ray Tube) and a liquid crystal display apparatus can be cited.

A keyboard 15a and a mouse 15b are connected to the input interface 15. The input interface 15 sends a signal sent from the keyboard 15a or the mouse 15b to the processor 11. The mouse 15b is an example of the pointing device and other pointing devices may also be used. Examples of other pointing devices include a touch panel, a tablet, a touch pad, and a track ball.

The optical drive apparatus 16 reads data recorded on an optical disk 16a using laser light or the like. The optical disk 16a is a portable non-transitory recording medium on which data is recorded readably by reflection of light. Examples of the optical disk 16a include DVD (Digital Versatile Disc), DVD-RAM, CD-ROM (Compact Disc Read Only Memory), and CD-R (Recordable)/RW (ReWritable).

The device connection interface 17 is a communication interface to connect peripheral devices to the computer 10. For example, a memory device 17a or a memory reader writer 17b can be connected to the device connection interface 17. The memory device 17a is a non-transitory recording medium mounted with a communication function with the device connection interface 17, for example, a USB (Universal Serial Bus) memory. The memory reader writer 17b writes data into a memory card 17c or reads data from the memory card 17c. The memory card 17c is a card non-transitory recording medium.

The network interface 18 is connected to a network 18a. The network interface 18 sends/receives data to/from other computers or communication devices via the network 18a.

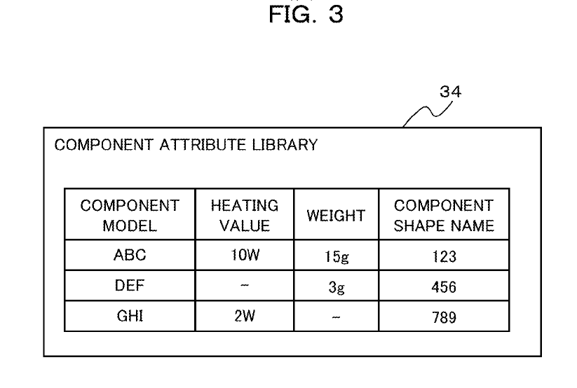

Using the computer 10 having the above hardware configuration, the component arrangement function in the present embodiment described below with reference to FIGS. 3 to 22 can be realized.

The computer 10 realizes the component arrangement function in the present embodiment by executing a program (such as a component arrangement program) recorded in, for example, a computer-readable non-transitory recording medium. A program describing processing content the computer 10 is caused to perform can be recorded in various recording media. For example, a program the computer 10 is caused to execute can be stored in the HDD 13. The processor 11 loads at least a portion of programs in the HDD 13 into the RAM 12 and executes the loaded programs.

Also, programs the computer 10 (the processor 11) is caused to execute can be recorded in a non-transitory portable recording medium such as the optical disk 16a, the memory device 17a, the memory card 17c or the like. A program stored in a portable recording medium becomes executable after being installed on the HDD 13 under the control of, for example, the processor 11. The processor 11 can also read a program directly from the portable recording medium and execute the program.

### [4] Function Configuration of the Information Processing Apparatus Having the Component Arrangement Function

Next, the function configuration of the information processing apparatus (computer) 10 having the component arrangement function in the present embodiment will be described with reference to FIG. 1. FIG. 1 is a block diagram showing an example of the function configuration.

The computer 10 includes, as shown in FIG. 1, the functions of a processing unit 20, a storage unit 30, an input unit 40, and a display unit 50 to arrange a plurality of components on a board such as a printed wiring board while doing an interference check.

The processing unit 20 is, for example, as shown in FIG. 2, the processor 11 and performs the functions of an interference check determination unit 21, an arrangement position determination unit 22, and a check region combination unit 23 described below by executing the above component arrangement program.

The storage unit (database unit) 30 is, for example, as shown in FIG. 2, the RAM 12 or the HDD 13 and stores various kinds of information to realize the component arrangement function. The various kinds of information include a network connection table 31, a component arrangement table 32, a board shape library 33, a component attribute library 34, a component shape library 35, an occupation region control table 36, an obstacle management table 37, an error flag, and a region combination flag.

The input unit 40 is, for example, as shown in FIG. 2, the keyboard 15a or the mouse 15b and gives arrangement instructions (for example, a drag & drop operation of a component) of each component operated by the user on the board. Instead of the mouse 15b, a touch panel, a tablet, a touch pad, a track ball or the like may be used.

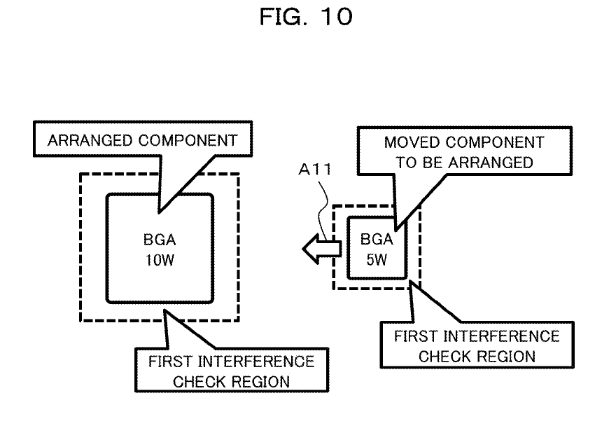

The display unit 50 is, for example, as shown in FIG. 2, the monitor 14a and displays, when the user performs a determination operation of the arrangement position of the component to be arranged using the computer 10 in the present embodiment, images as shown in, for example, FIGS. 10 to 28, that is, images displaying the arrangement progress of components. When the wiring board C and the various components C1 to C9 to be arranged are displayed in the display unit 50 in the present embodiment, the rats nest display described above with reference to FIGS. 23 to 28 is also made simultaneously.

The network connection table 31 holds connecting relationships between pins of the components C1 to C9 and the connector C0 arranged on the board C as shown in, for example, FIGS. 23 to 28 as network connection information. Based on network connection information held in the network connection table 31, the rats nest display (see dotted lines) described above with reference to FIGS. 23 to 28 is made in the display unit 50.

The component arrangement table 32 holds information about the arrangement position of each component arranged on the board C.

The board shape library 33 holds information about the outside shape of the board C on which components are arranged and information about arrangement enabled regions of components on the board C.

The component attribute library 34 associates and holds, for example, as shown in FIG. 3, the component model, heating value (element name), weight (element name), and component shape name for each component arranged on the board C. FIG. 3 is a diagram showing an example of the component attribute library 34 in the present embodiment.

The component model is information (such as the component name or the product name) that identifies a component. The heating value is one predetermined element (attribute) of the component identified by the component model and, as the heating value, the value (W value, wattage) of the heating value generated by the component is held as attribute values (first attribute value, second attribute value) of the predetermined element (heating value). Similarly, the weight is one predetermined element (attribute) of the component identified by the component model and, as the weight, the value (g value) of the weight possessed by the component is held as attribute values (first attribute value, second attribute value) of the predetermined element (weight). The component shape name is information identifying the physical shape of a component identified by the component model.

In the component attribute library 34, in addition to the heating value and weight, information about the electromagnetic field (element name) may be held as one predetermined element (attribute) for each component model.

In this case, the value (dBm value) of the electromagnetic field generated by a component identified by the component model is held as attribute values (first attribute value, second attribute value) of the predetermined element (electromagnetic field).

FIG. 3 shows an example in which information about components of three component models is entered in the component attribute library 34. In the top row, the component of a component model ABC is entered as a component that generates heat of 10 W, has a weight of 15 g, and has a physical shape of a component shape name 123. In the middle row, the component of a component model DEF is entered as a component that generates no heat, has a weight of 3 g, and has a physical shape of a component shape name 456. In the bottom row, the component of a component model GHI is entered as a component that generates heat of 2 W, has no weight causing deformation of the board C, and has a physical shape of a component shape name 789.

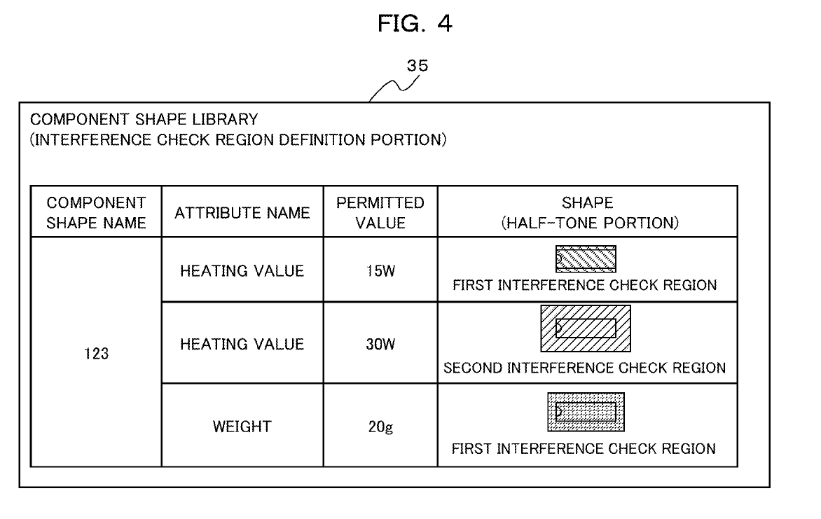

The component shape library 35 associates and holds, for example, as shown in FIG. 4, the element name, the permitted value for the element (attribute) identified by the element name, and information to identify interference check regions for the physical shape (occupation region) identified by the component shape name for each component shape name. FIG. 4 is a diagram showing an example of the component shape library (interference check region definition unit) 35 in the present embodiment.

The permitted value is set for each interference check region and corresponds to the maximum value of the attribute value of the predetermined element that can be permitted in the relevant interference check region. As an interference check region, a region wider than the physical shape (occupation region) of the corresponding component is set. In the field of “Shape (Half-tone portion)” of the component shape library 35 shown in FIG. 4, the half-tone portion (diagonally shaded portion) indicates an interference check region and the rectangle in each interference check region corresponds to the physical shape (occupation region) identified by the component shape name.

FIG. 4 shows an example in which three interference check regions of a component having a physical shape identified by the component shape name 123 are entered in the component shape library 35. In the top row, a first interference check region to which the permitted value 15 W of the heating value is set is entered. In the middle row, a second interference check region, which is wider than the first interference check region, to which the permitted value 30 W of the heating value is set is entered. In the bottom row, a first interference check region to which the permitted value 20 g of the weight is set is entered.

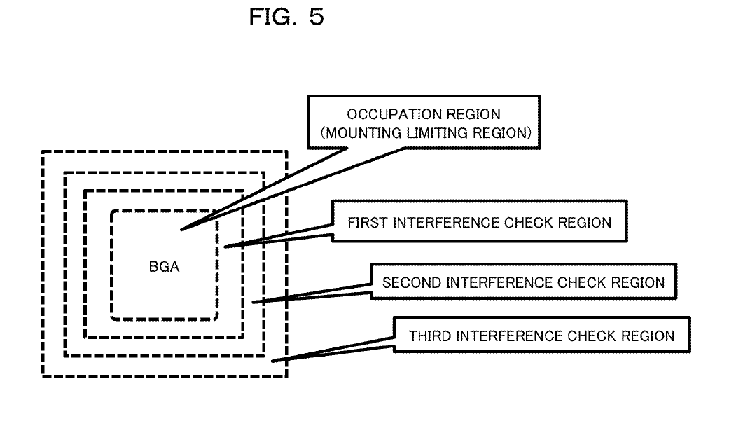

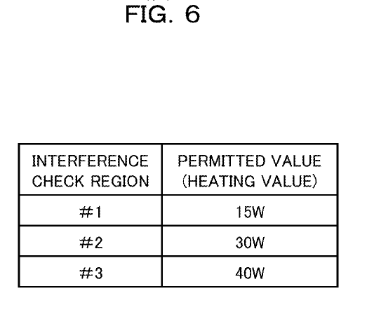

In an example described below with reference to FIGS. 10 to 22, as shown in FIG. 5, the type of the component is the BGA package and a case in which three interference check regions are set for each component will be described. Also, a case in which the predetermined element (attribute) of each component is the heating value will be described. In this case, as shown in FIG. 6, mutually different permitted values of the heating value are set for each of the three interference check regions. The absolute value of the permitted value increases with an increasing interference check region.

FIG. 5 is a diagram illustrating a plurality of interference check regions set for each component in the present embodiment. In the example shown in FIG. 5, for the occupation region of the component (BGA), a first interference check region wider than the occupation region is set, a second interference check region wider than the first interference check region is set, and a third interference check region wider than the second interference check region is set. The occupation region is a range physically occupied by the component body and may also be referred to as a mounting limiting region. The first to third interference check regions may be denoted as #1, #2, #3 in the diagrams respectively.

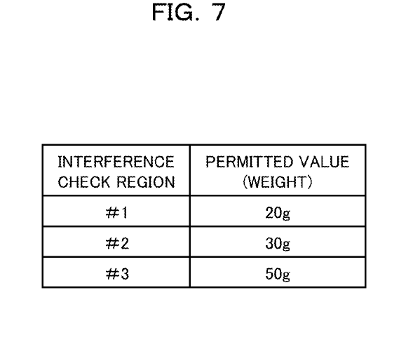

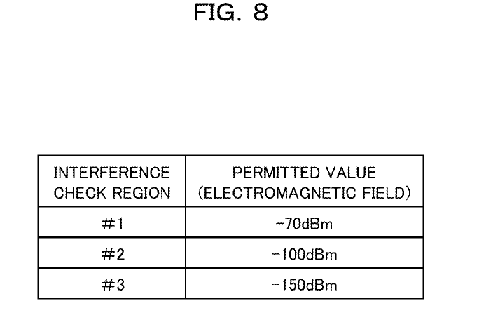

FIG. 6 is a diagram showing an example of the permitted value set to each interference check region when the predetermined element is the heating value. In the example shown in FIG. 6, 15 W, 30 W, and 40 W are set to the first to third interference check regions as the permitted value of the heating value respectively. In the present embodiment, a case in which the predetermined element is a heating value will be described, but the present embodiment is not limited to such an example and when the attribute value (physical property value) is the weight or an electromagnetic field of a component other than the heating value, the present embodiment is similarly applied like the case of the heating value. For example, FIG. 7 is a diagram showing an example of the permitted value set to each interference check region when the predetermined element is the weight. In the example shown in FIG. 7, 20 g, 30 g, and 50 g are set to the first to third interference check regions as the permitted value of the weight respectively. FIG. 8 is a diagram showing an example of the permitted value set to each interference check region when the predetermined element is the electromagnetic field. In the example shown in FIG. 8, −70 dBm, −100 dBm, and −150 dBm are set to the first to third interference check regions as the permitted value of the electromagnetic field respectively.

The number of interference check regions set for each component is not limited to three and the number thereof may be one, two, four or more. In such a case, different permitted values of the predetermined element are set for each of a plurality of interference check regions. Information about the interference check regions and permitted values described above with reference to FIGS. 5 to 8 is entered in the component shape library 35 described above with reference to FIG. 4. Further, the type of component is not limited to the BGA package and may be the QFP, QFJ package, SOP, SOJ package, IMD, or SMD.

The occupation region control table 36 holds information about the occupation region (see FIGS. 4 and 5) of each component arranged on the board C.

The obstacle management table 37 has information about the arrangement position of the component whose arrangement position is determined and confirmed by the arrangement position determination unit 22 described below entered as information about obstacles.

The network connection table 31, the component arrangement table 32, the board shape library 33, the component attribute library 34, the component shape library 35, the occupation region control table 36, and the obstacle management table 37 described above are stored in the storage unit 30 in advance or created, entered, and updated by the processing unit 20 when necessary. The table or library indicated by reference numerals 31 to 37 may also be input from the input unit 40 or from the optical disk 16a, the memory card 17c, or the network 18a shown in FIG. 2.

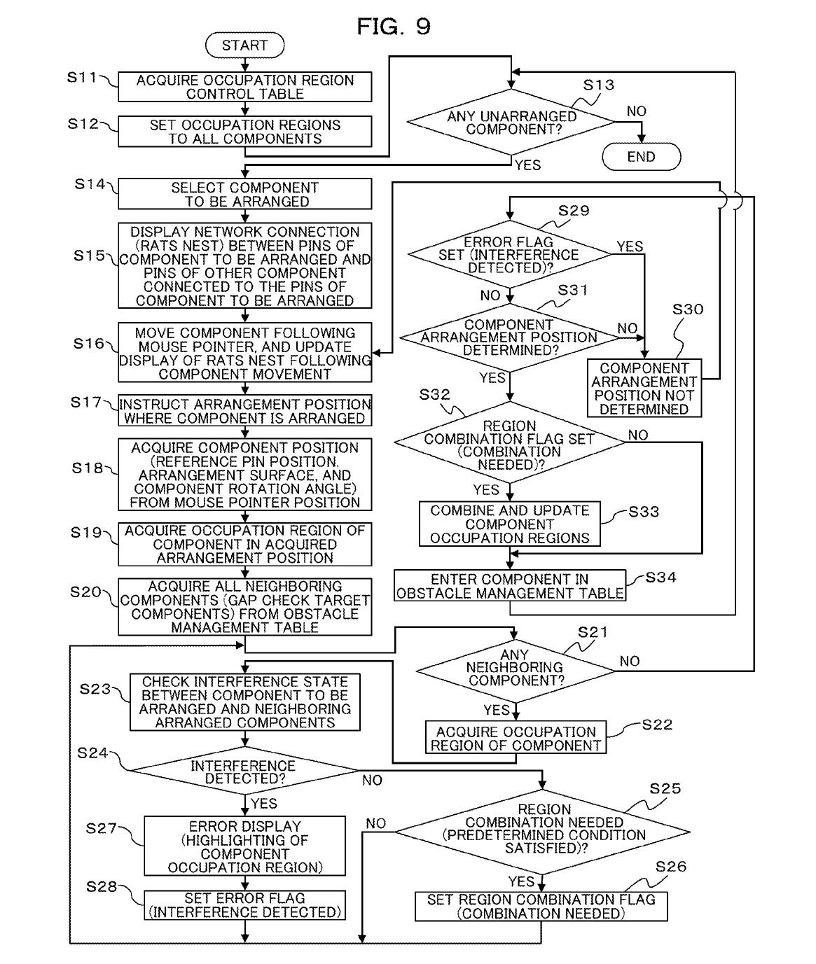

Then, the interference check determination unit 21, the arrangement position determination unit 22, and the check region combination unit 23 operate according to the flow chart in FIG. 9 shown below while referring to the network connection table 31, the component arrangement table 32, the board shape library 33, the component attribute library 34, the component shape library 35, the occupation region control table 36, or the obstacle management table 37 when necessary.

The interference check determination unit 21 checks an interference state between an interference check region (first check region) set to the component to be arranged selected by the user and an interference check region (second check region) set to an arranged component (neighboring component, nearby component) near the component to be arranged. More specifically, the interference check determination unit 21 determines whether the interference state satisfies predetermined conditions described below. Here, interference check regions of the component to be arranged and interference check regions of an arranged component are acquired by referring to and searching the component shape library 35. Information about arranged components near the component to be arranged is acquired from the obstacle management table 37.

If the checked interference state satisfies predetermined conditions, the arrangement position determination unit 22 determines the arrangement position of the component to be arranged by permitting the interference state. If no region combination flag (combination needed) described below with reference to FIG. 9 is set, the arrangement position determination unit 22 enters information about the component to be arranged (including information about the arrangement position) in the obstacle management table 37 in accordance with a determination instruction described below with reference to FIG. 9.

The predetermined conditions may be satisfying, for example, three points (a1′) to (a3′) below similar to the aforementioned three points (a1) to (a3). The predetermined conditions will be used for Example 1 to Example 3 described below with reference to FIGS. 10 to 18:

(a1′) The same permitted value of the heating value permitting the interference state is set to the interference check region of the component to be arranged and the interference check region of an arranged component;

(a2′) The interference check region of the component to be arranged and the interference check region of the arranged component interfere; and

(a3′) The total value of an attribute value (first attribute value) related to the heating value of the component to be arranged and an attribute value (second attribute value) related to the heating value of the arranged component is equal to or less than the permitted value.

The permitted value in (a1′) and (a3′) described above can be obtained by referring to and searching the component shape library 35. The first attribute value and the second attribute value in (a3′) described above can be obtained by referring to and searching the component attribute library 34.

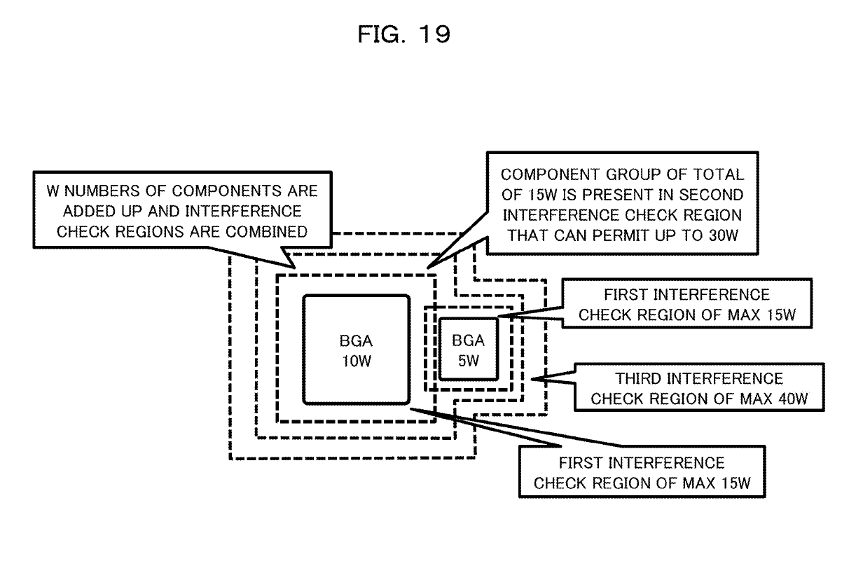

The predetermined conditions may also be satisfying, for example, three points (b1′) to (b3′) below similar to the aforementioned three points (b1) to (b3). The predetermined conditions will be used for Example 4 described below with reference to FIGS. 19 to 21:

(b1′) The same permitted value of the heating value (heat capacity) permitting the interference state is set to the interference check region of the component to be arranged and the interference check region of an arranged component;

(b2′) The interference check region of the component to be arranged or the interference check region of the arranged component and the occupation region (first occupation region) of the component to be arranged or the occupation region (second occupation region) of the arranged component interfere; and

(b3′) The total value of an attribute value (first attribute value) related to the heating value of the component to be arranged and an attribute value (second attribute value) related to the heating value of the arranged component is equal to or less than the same permitted value.

The permitted value in (b1′) and (b3′) described above can be obtained by referring to and searching the component shape library 35. The first occupation region and the second occupation region in (b2′) described above can be obtained by referring to and searching the occupation region control table 36. The first attribute value and the second attribute value in (b3′) described above can be obtained by referring to and searching the component attribute library 34.

If the checked interference state satisfies predetermined conditions and the arrangement position of the component to be arranged is determined, the check region combination unit 23 combines the interference check region (first check region) of the component to be arranged and the interference check region (second check region) of the arranged component. That is, if the region combination flag (combination needed) described below with reference to FIG. 9 is set, the check region combination unit 23 combines the interference check regions in accordance with the determination instruction described below with reference to FIG. 9. Then, the check region combination unit 23 enters information about the component to be arranged and the arranged component (including information about the arrangement positions) combined as one arranged component to which one interference check region (one check region) is set in the obstacle management table 37.

In the information processing apparatus 10 in the present embodiment configured as described above, an interference check region with a nearby component is set to each component and elements (the heating value, weight, electromagnetic field and the like) permitting interference of component with the interference check region are set. The attribute value of the element is set to each component and also the permitted value is set to the interference check region of each component. When the interference check region of the component to be arranged and the interference check region of a nearby component interfere, if the total of attribute values of the predetermined element is equal to or less than the permitted value set to the interference check region, the interference of the interference check regions is permitted. Then, the interference check regions having the same permitted value are combined and in the subsequent processes, the component to be arranged and the nearby component are handled as one arranged component having the combined interference check region.

That is, if the interference check region of another component to be arranged interferes with the interference check region combined as described above, the attribute value of the predetermined element set to the other component to be arranged is added to the total value of attribute values of the predetermined element set to each of a plurality of components present in the combined interference check region. If the added value is equal to or less than the permitted value set to the interference check region, the interference of the relevant interference check regions is permitted and the interference check regions having the same permitted value are further combined.

### [5] Operation of the Information Processing Apparatus in the Present Embodiment

Next, following the flow chart (steps S11 to S34) shown in FIG. 9, an example of the operation (determination procedure of the arrangement position of the component to be arranged) of the information processing apparatus 10 having the aforementioned component arrangement function will be described with reference to FIGS. 1 and 2. Incidentally, steps S13 to S24, S27 to S31, and S34 shown in FIG. 9 perform processes corresponding to respective steps S101 to S118 shown in FIG. 29. Also, steps S25, S26, S32, and S33 shown in FIG. 9 perform processes added in the present embodiment.

First, the processing unit 20 acquires the occupation region control table 36 from the storage unit 30 (step S11) and sets occupation regions (mounting limiting regions) of all the components C1 to C9 to be arranged on the board C (step S12).

Then, the processing unit 20 determines whether there is any unarranged component (step S13) and if there is no unarranged component (NO route in step S13), the process terminates. On the other hand, if there is an unarranged component (YES route in step S13), the component to be arranged is selected and moved in accordance with a mouse operation of the user (step S14).

At this point, as shown in FIGS. 23 to 28, a network connection (rats nest) of pins of the component to be arranged and pins of other components connected to the pins is displayed in a display unit based on network connection information (step S15). Then, the processing unit 20 moves the component to be arranged following a mouse pointer and also updates the display state of the rats nest following the movement of the component to be arranged (step S16).

Then, the user moves the component to be arranged to a desired position on the board by a mouse operation and instructs the arrangement position (step S17). When an instruction of the arrangement position is received, the processing unit 20 acquires the arrangement position (such as the reference pin position, arrangement surface, and component rotation angle) of the component to be arranged based on the position of the mouse pointer (step S18). Then, the processing unit 20 acquires an occupation region of the component to be arranged in the acquired arrangement position (step S19) and also acquires all neighboring components (nearby components, gap check target components) near the component to be arranged from the obstacle management table 37 (step S20).

Next, the processing unit 20 determines whether there is any neighboring component (step S21) and if there is an unprocessed neighboring component (YES route in step S21), selects one neighboring component (arranged component). Then, the processing unit 20 (interference check determination unit 21) acquires the occupation region of the component to be arranged and the occupation region of the selected one neighboring component (step S22) and checks whether interference occurs between these occupation regions (steps S23, S24). In the occupation region interference check, whether the component to be arranged and an arranged neighboring component interfere physically may be checked or whether a gap of a predetermined interval can be secured between the occupation region of the component to be arranged and the occupation region of an arranged neighboring component may be checked.

In steps S23, S24, the processing unit 20 (interference check determination unit 21) checks an interference state between the interference check region of the component to be arranged and the interference check region of the arranged component. In the interference check of the interference check regions, the processing unit 20 (interference check determination unit 21) determines whether the aforementioned predetermined conditions [(a1′) to (a3′) described above or (b1′) to (b3′) described above] are satisfied.

If the occupation region of the component to be arranged and the occupation region of one arranged component interfere or (a3′) described above is not satisfied even if (a1′) and (a2′) described above are satisfied, the interference check determination unit 21 determines that interference occurs. A state that does not satisfy (a3′) described above is a state in which the total value of the heating value (first attribute value) of the component to be arranged and the heating value (second attribute value) of the arranged component exceeds the permitted value. This also applies when, instead of (a1′) to (a3′) described above, (b1′) to (b3′) described above are used as predetermined conditions.

If it is determined that interference occurs (YES route in step S24), the processing unit 20 makes an error display of the component to be arranged or one arranged component in the display unit 50 (step S27). The error display is made by, for example, highlighting the component to be arranged or one arranged component in the display unit 50. Then, the processing unit 20 sets an error flag (interference) indicating that the component to be arranged and the one arranged component interfere in the storage unit 30 (step S28) before returning to the process of step S21.

If the occupation region of the component to be arranged and the occupation region of one arranged component does not interfere and (a3′) or (b3′) described above is satisfied, the interference check determination unit 21 determines that interference does not occur. Here, a state in which (a3′) or (b3′) described above is satisfied is a state in which the total value of the heating value (first attribute value) of the component to be arranged and the heating value (second attribute value) of an arranged component is equal to or less than the permitted value.

If it is determined that interference does not occur (NO route in step S24), the processing unit 20 (interference check determination unit 21) determines whether it is necessary to combine the interference check regions based on the result of interference check of the interference check regions in step S23 (step S25). If it is not necessary to combine the interference check regions (NO route in step S25), the processing unit 20 returns to the process of step S21.

On the other hand, if it is necessary to combine the interference check regions (YES route in step S25), the processing unit 20 sets a region combination flag (combination needed) indicating that it is necessary to combine the interference check region of the component to be arranged and the interference check region of the one arranged component in the storage unit 30 (step S26) before returning to the process of step S21.

If it is determined in step S21 that there is no unprocessed neighboring component (NO route in step S21), the processing unit 20 determines whether at least one error flag (interference) is set (step S29). If at least one error flag (interference) is set (YES route in step S29), the processing unit 20 determines that an interference state arises with a neighboring component (arranged component) in the position where the component to be arranged is arranged this time and leaves the component arrangement position undetermined (step S30). Then, the processing unit 20 returns to the process of step S16 to continue the movement of the component to be arranged through a mouse operation of the user.

On the other hand, if no error flag (interference) is set (NO route in step S29), the processing unit 20 determines that an interference state does not arise with a neighboring component in the position where the component to be arranged is arranged this time and determines whether to confirm the arrangement position this time as the arrangement position of the component to be arranged (step S31). If a determination instruction is received from a mouse operation of the user or the like, the processing unit 20 determines that the arrangement position this time is confirmed as the arrangement position of the component to be arranged (YES route in step S31) and further determines whether a region combination flag (combination needed) is set (step S32).

If no region combination flag (combination needed) is not set (NO route in step S32), the processing unit 20 (arrangement position determination unit 22) determines/confirms the current position as the arrangement position of the component to be arranged and enters information about the component to be arranged (including information about the arrangement position) in the obstacle management table 37 (step S34). Then, the processing unit 20 returns to the process of step S13.

If the region combination flag (combination needed) is set (YES route in step S32), the processing unit 20 (check region combination unit 23) combines the interference check regions corresponding to the region combination flag (step S33). Then, the check region combination unit 23 enters information about the component to be arranged and the arranged component (including information about the arrangement positions) combined as one arranged component to which one interference check region (one check region) is set in the obstacle management table 37 (step S34). Then, the processing unit 20 returns to the process of step S13.

If no determination instruction is received from the user or an instruction not to determine is received from a mouse operation of the user, the processing unit 20 determines that the arrangement position this time is not determined as the arrangement position of the component to be arranged (NO route in step S31). Then, the processing unit 20 leaves the component arrangement position undetermined (step S30) and returns to the process of step S16 to continue the movement of the component to be arranged through a mouse operation of the user.

### [6] Concrete Examples of the Present Embodiment

Next, concrete examples (manipulation examples, operation examples) of the present embodiment by the information processing apparatus 10 according to the present embodiment configured to operate as described above will be described with reference to FIGS. 10 to 22. In the examples described below, however, a case in which the predetermined element is the heating value and each component is a BGA package will be described. Further, in the examples described below, a case in which first to third interference check regions as shown in FIG. 5 are set to each component and, as shown in FIG. 6, the permitted values (MAX) 15 W, 30 W, and 40 W of the heating value are set to the first to third interference check regions respectively will be described.

### [6-1] Example 1

FIGS. 10 to 12 are diagrams illustrating Example 1 of a concrete arrangement position determination procedure of the component to be arranged according to the present embodiment.

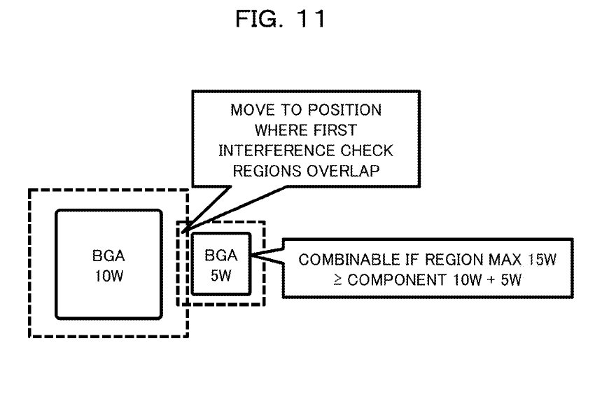

In Example 1, as shown in FIG. 10, a case in which a BGA package component of the heating value 5 W is newly arranged as a component to be arranged while a BGA package component of the heating value is 10 W is arranged on a board as an arranged component will be described. In FIGS. 10 and 11, however, the description focuses on the first interference regions of the component to be arranged and the arranged component.

In Example 1, as shown in FIG. 10, the component to be arranged is moved in an arrow A11 direction by a mouse operation of the user or the like. Then, as shown in FIG. 11, the component to be arranged is brought closer to the arranged component until a position where the first interference check region of the component to be arranged and the first interference check region of the arranged component overlap (interfere) with each other.

At this point, the same permitted value (MAX) 15 W is set for the same element (heating value) to the first interference check region of the arranged component and the first interference check region of the component to be arranged. Further, the arranged component and the component to be arranged become a component group having the heating value of 15 W as a total value of the heating value 10 W of the arranged component and the heating value 5 W of the component to be arranged. Then, the total value of 15 W is equal to or less than the permitted value 15 W of the first interference check regions interfering with each other.

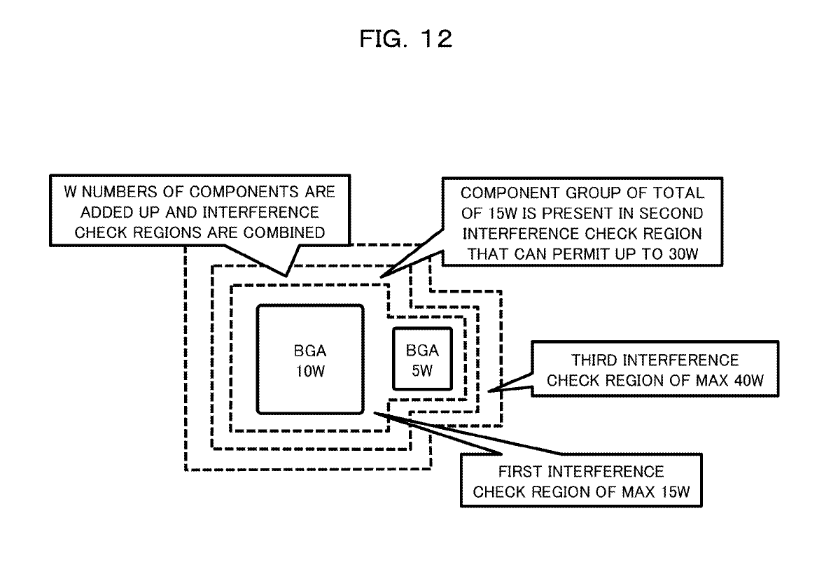

Thus, in the arrangement state shown in FIG. 11, the predetermined conditions (a1′) to (a3′) described above are satisfied and an interference check error does not occur and therefore, the arrangement position of the component to be arranged can be determined in the arrangement state shown in FIG. 11 and the arrangement can be confirmed. If the arrangement position is confirmed in the arrangement state shown in FIG. 11, the first interference check region of the arranged component and the first interference check region of the component to be arranged can be combined. Then, a component group of the arranged component and the component to be arranged can be entered as one arranged component to which one combined first interference check region (see FIG. 12) is set.

At this point, as shown in FIG. 12, the second interference check regions and the third interference check regions set to the arranged component and the component to be arranged are similarly combined like the first interference check regions. That is, the second interference check region and the third interference check region can permit up to 30 W and 40 W respectively. The total value of 15 W of the heating values of the arranged component and the component to be arranged is equal to or less than the permitted values of 30 W and 40 W of the second interference check region and the third interference check region respectively.

Therefore, for both of the second interference check region and the third interference check region, the predetermined conditions (a1′) to (a3′) described above are satisfied and an interference check error due to overlapping regions does not occur. Thus, like the first interference check regions, regions are combined by regions having the same permitted value of the same element being overlapped. Then, a component group of the arranged component and the component to be arranged is entered as one arranged component to which one combined second interference check region and one combined third interference check region are set.

### [6-2] Example 2

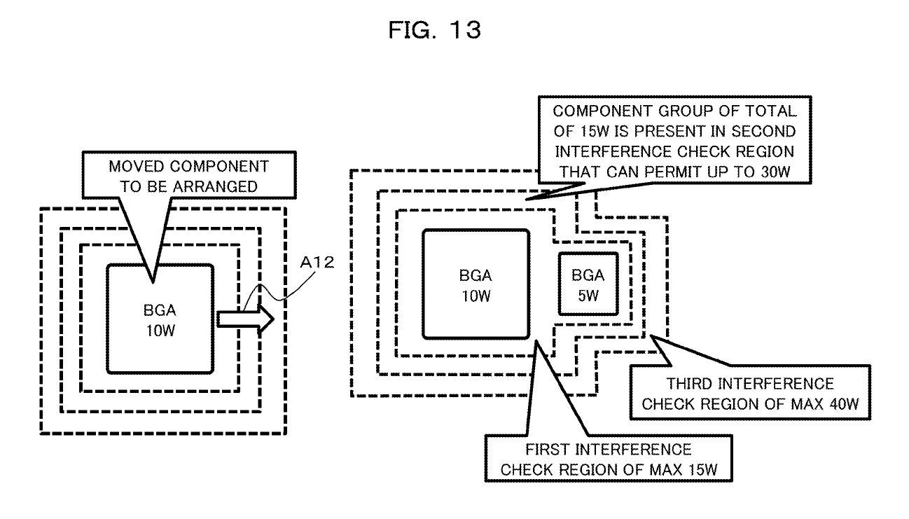

FIGS. 13 to 15 are diagrams illustrating Example 2 of the concrete arrangement position determination procedure of the component to be arranged according to the present embodiment.

In Example 2, a case in which in the arrangement state shown in FIG. 12, that is, in a state in which a component group of the total heating value of 15 W containing two components is arranged on a board as arranged components, as shown in FIG. 13, another BGA package component of the heating value 10 W is newly arranged as a component to be arranged will be described.

In Example 2, as shown in FIG. 13, the component to be arranged is moved in an arrow A12 direction by a mouse operation of the user or the like. Then, when the component to be arranged is brought closer to the component group of the total heating value of 15 W, the third interference check region of the component to be arranged and the third interference check region of the component group first interfere. At this point, the total value of the heating values of a component group contained in the third interference check region is 25 W, which is equal to or less than the permitted value 40 W of the third interference check region, and thus, an interference check error does not occur and the arrangement position of the component to be arranged can be determined and the arrangement can be confirmed.

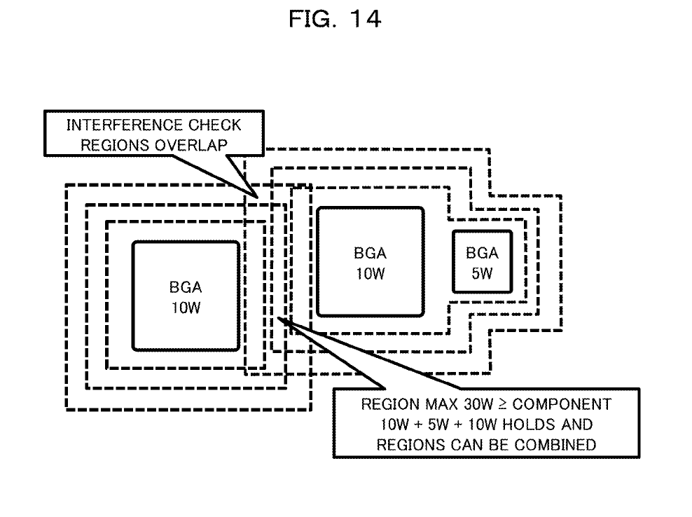

When the component to be arranged is further brought closer to the component group of the total heating value of 15 W, as shown in FIG. 14, the second interference check regions of the permitted value 30 W of the heating value interfere with each other. At this point, the total value of the heating values of a component group contained in the second interference check region is 25 W, which is equal to or less than the permitted value 30 W of the second interference check region, and thus, an interference check error does not occur and the arrangement position of the component to be arranged can be determined and the arrangement can be confirmed.

When the component to be arranged is further brought closer to the component group, the first interference check regions of the permitted value 15 W of the heating value interfere with each other. At this point, the total value of the heating values of a component group contained in the first interference check region is 25 W, which exceeds the permitted value 15 W of the first interference check region, and thus, an interference check error occurs and the arrangement of the component to be arranged cannot be confirmed.

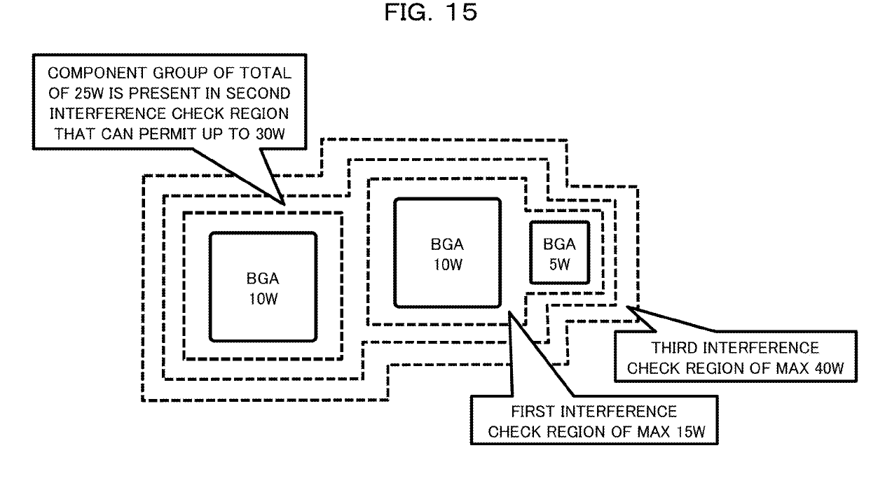

Therefore, if the arrangement of components is confirmed in the arrangement state shown in FIG. 14, as shown in FIG. 15, the third interference check regions are combined and further, the second interference check regions are combined.

### [6-3] Example 3

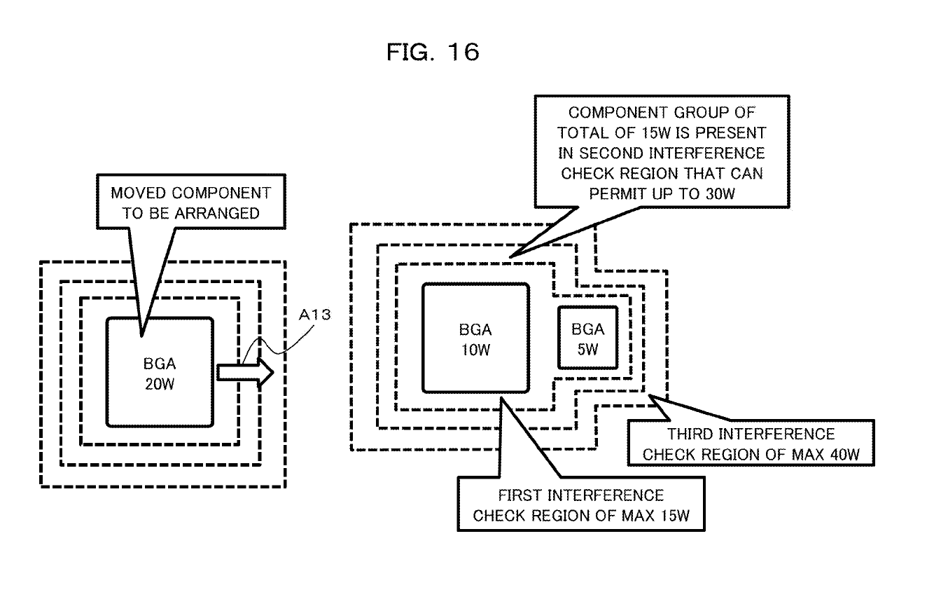

FIGS. 16 to 18 are diagrams illustrating Example 3 of the concrete arrangement position determination procedure of the component to be arranged according to the present embodiment.

In Example 3, a case in which in the arrangement state shown in FIG. 12, that is, in a state in which a component group of the total heating value of 15 W containing two components is arranged on a board as arranged components, as shown in FIG. 16, another BGA package component of the heating value 20 W is newly arranged as a component to be arranged will be described.

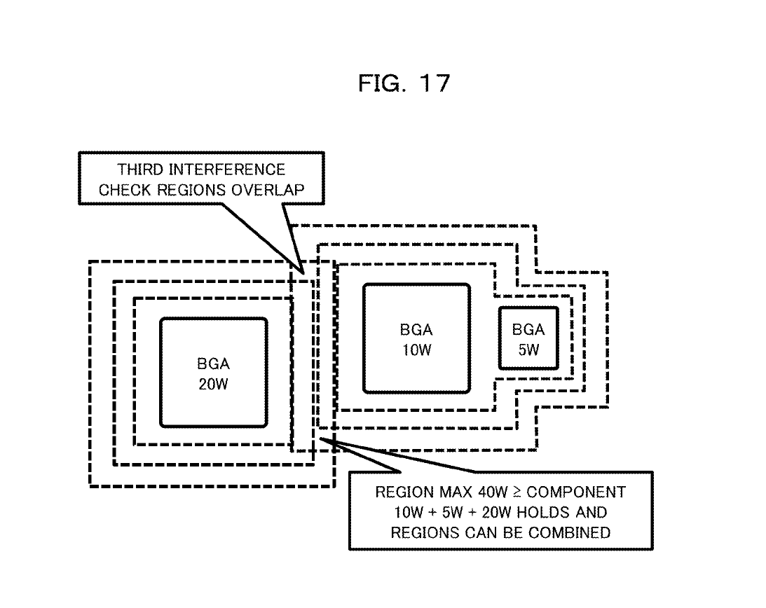

In Example 3, as shown in FIG. 16, the component to be arranged is moved in an arrow A13 direction by a mouse operation of the user or the like. Then, when the component to be arranged is brought closer to the component group of the total heating value of 15 W, as shown in FIG. 17, the third interference check region of the component to be arranged and the third interference check region of the component group interfere. At this point, the total value of the heating values of a component group contained in the third interference check region is 35 W, which is equal to or less than the permitted value 40 W of the third interference check region, and thus, an interference check error does not occur and the arrangement position of the component to be arranged can be determined and the arrangement can be confirmed.

When the component to be arranged is further brought closer to the component group of the total heating value of 15 W, the second interference check regions of the permitted value 30 W of the heating value interfere with each other. At this point, the total value of the heating values of a component group contained in the second interference check region is 35 W, which exceeds the permitted value 30 W of the second interference check region, and thus, an interference check error occurs and the arrangement of the component to be arranged cannot be confirmed.

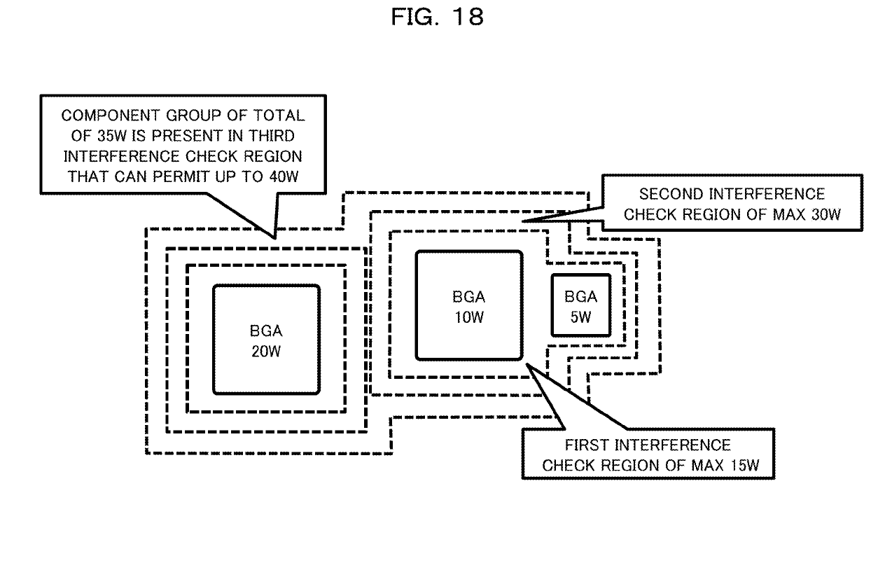

Therefore, if the arrangement of components is confirmed in the arrangement state shown in FIG. 14, as shown in FIG. 18, the third interference check regions are combined.

### [6-4] Example 4

FIGS. 19 to 21 are diagrams illustrating Example 4 of the concrete arrangement position determination procedure of the component to be arranged according to the present embodiment.

In Examples 1 to 3, a case in which an interference check is done based on the aforementioned predetermined conditions (a1′) to (a3′), that is, an interference check of interference check regions to which the same permitted value of the same element (attribute) is done has been described. In Example 4, by contrast, a case in which an interference check is done based on the aforementioned predetermined conditions (b1′) to (b3′), that is, an interference check between the interference check region of one component and the mounting limiting region (occupation region) of the other component is done will be described.

In Example 4, like Example 1 shown in FIG. 10, a case in which a BGA package component of the heating value 5 W is newly arranged as a component to be arranged while a BGA package component of the heating value is 10 W is arranged on a board as an arranged component will be described.

When the component of 5 W is brought closer to the arranged component of 10 W by a mouse operation of the user or the like and moved from the position shown in FIG. 10 to the position shown in FIG. 19, the third and second interference check regions of the arranged component and the mounting limiting region of the moved component to be arranged of 5 W interfere with each other. At this point, the total value of the heating values is 15 W, which is equal to or less than the permitted value 40 W of the heating value of the third and second interference check regions, and thus, the third interference check region of the arranged component and the third interference check region of the component to be arranged can be combined. Similarly, the total value 15 W of the heating values is equal to or less than the permitted value 30 W of the heating value of the second interference check regions and thus, the second interference check region of the arranged component and the second interference check region of the component to be arranged can also be combined.

In the position of the component to be arranged of 5 W shown in FIG. 19, however, the mounting limiting region of the component to be arranged and the first interference check region of the arranged component of 10 W do not interfere and similarly, the first interference check region of the component to be arranged and the mounting limiting region of the arranged component of 10 W do not interfere. Thus, the first interference check region of the component to be arranged and the first interference check region of the arranged component are not combined, each of the component to be arranged and the arranged component has the first interference check region of the permitted value 15 W, and the components are not entered as one component group for the first interference check region.

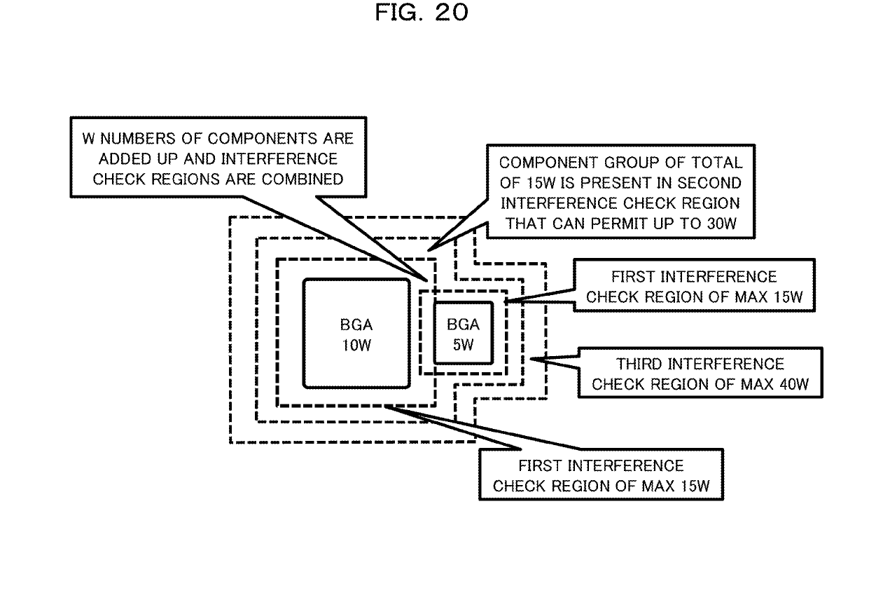

When the component of 5 W is further brought closer to the arranged component of 10 W by a mouse operation of the user or the like and moved from the position shown in FIG. 19 to the position shown in FIG. 20, the mounting limiting region of the component to be arranged and the first interference check region of the arranged component of 10 W interfere. At this point, the total value of the heating values is 15 W, which is equal to or less than the permitted value 15 W of the heating value of the first interference check region, and thus, the first interference check region of the arranged component and the first interference check region of the component to be arranged can now be combined.

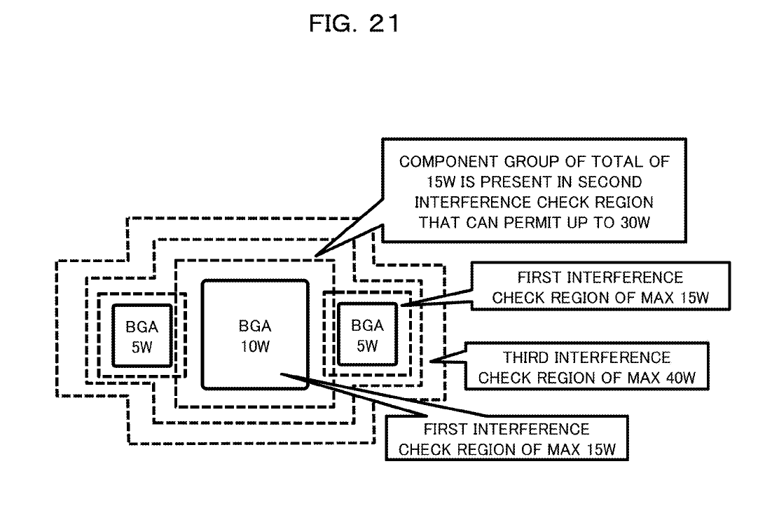

When an interference check between an interference check region and a mounting limiting region of another component is done, it is assumed that in the arrangement state shown in FIG. 19, a component of the heating value 5 W is further arranged as shown in FIG. 21 on the left side of the arranged component of 10 W. In the arrangement state shown in FIG. 21, like the component of 5 W on the right side, the component of 5 W on the left side does not interfere with the first interference check region and the mounting limiting region. Thus, the first interference check regions of the three components are not combined. Each of the three components has the first interference check region of the permitted value 15 W, and the three components are not entered as one component group of the total value 20 W for the first interference check region.

### [6-5] Example 5

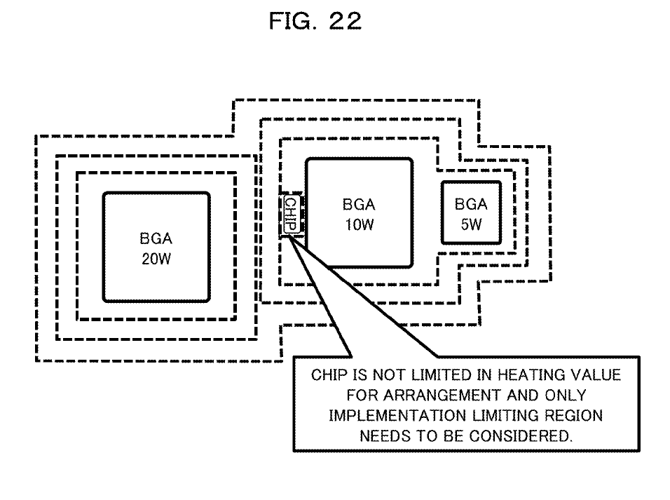

FIG. 22 is a diagram illustrating Example 5 of the concrete arrangement position determination procedure of the component to be arranged according to the present embodiment.

Heretofore, a case in which components having the heating value as an attribute value are arranged has been described, but in Example 5, a case in which like a component of the component model DEF in the component attribute library 34 shown in FIG. 3, a component that generates no heat or almost no heat is arranged will be described. Examples of such a component include, for example, a 2-terminal chip capacitor and a connector of a mechanism component.

In an arrangement state shown in, for example, FIG. 18, a 2-terminal chip capacitor (CHIP) as a component to be arranged to which no heating value is set is brought closer to an arranged component of 10 W. At this point, no attribute value to be checked for each of the first to third interference check regions of the component of 10 W is set to the 2-terminal chip component. Thus, the 2-terminal chip component is excluded from the check for the interference check regions. Therefore, as shown in FIG. 22, the 2-terminal chip component can be brought closer to a position where no error occurs in the interference check of mounting limiting regions near the BGA of 10 W to determine the arrangement position.

### [7] Effect of the Present Embodiment

According to the information processing apparatus 10 having the component arrangement function in the present embodiment described above, like the component shape library 35 shown in FIG. 4, interference check regions are associated for each component using the component shape name and the element name as keys. Then, when a component is arranged, if interference check regions having the same permitted value for the same element interfere, the interference is permitted and the interference check regions are combined if the total value of the attribute value of the component and the attribute value of a nearby component is equal to or less than the permitted value of the interference check regions of the component.

By providing interference check regions to which permitted values for a predetermined element (attribute) are set as described above for each component, not only an interference check between the component to be arranged and a nearby component (neighboring component), but also an interference check in consideration of the arrangement of nearby components therearound can be done. Accordingly, the arrangement position of the component to be arranged can be determined by considering the arrangement of a plurality of components therearound on a board and the check of the component to be newly arranged for the interference check regions is appropriately done in accordance with conditions of nearby components so that a high-density component arrangement can be designed.

Particularly in conventional technology, the interference check between the component to be arranged and a nearby component is done in a one-to-one relationship. In the present embodiment, by contrast, when the arrangement position of the component to be arranged is determined, the interference check can be done not only with an directly close component (neighboring component), but also by including a plurality of components therearound while being conscious of permitted values of elements (attributes) such as the heat, stress, and electromagnetic field. Therefore, arrangement work of the component to be arranged can be done efficiently.

### [8] Others

In the foregoing, a preferred embodiment of the present invention has been described, but the present invention is not limited to a specific embodiment and various modifications and alterations can be made without deviating from the spirit of the present invention.

In the embodiment described above, a case in which the predetermined element is the heating value is described, but the predetermined element is not limited to the above example and may be the weight, electromagnetic field or the like. Two elements or more may be combined. If, for example, two elements are combined, an interference check between the component to be arranged and a nearby component is done based on interference check regions having permitted value of the first element and an interference check is done based on interference check regions having permitted value of the second element. Then, if no interference check error occurs in both interference checks, the interference between the component to be arranged and the nearby component is permitted and the interference check regions are combined.

In the information processing apparatus 10 in the present embodiment, a component arrangement state on a board as shown in FIGS. 10 to 28 can be displayed in the display unit 50. In this case, whether to display interference check regions of each component in the display unit 50 can be switched. Also by switching whether to display combined check regions that have been combined in the display unit 50, a state in which combined check regions are displayed and a state in which interference check regions of each component are displayed without displaying combined check regions can be switched. Further, by switching the reverse video display in the display unit 50, regions without interference check regions can explicitly be displayed and the state of regions where a component can be arranged on the board can thereby be recognized visually.

Further, in the embodiment described above, a case in which the component to be arranged is arranged near another component and interference check regions interfere and are combined has been described. In contrast, by moving one component belonging to an arranged component group whose interference check region has been combined away from other components of the component group in a reverse procedure of the procedure used to combine interference check regions, an arrangement state in which the interference check regions do not interfere with each other can be restored.

According to an embodiment, the arrangement position of a component to be arranged can be determined by considering the arrangement of a plurality of components therearound on a board.

All examples and conditional language provided herein are intended for the pedagogical purposes of aiding the reader in understanding the invention and the concepts contributed by the inventor to further the art, and are not to be construed limitations to such specifically recited examples and conditions, nor does the organization of such examples in the specification relate to a showing of the superiority and inferiority of the invention. Although one or more embodiments of the present inventions have been described in detail, it should be understood that the various changes, substitutions, and alterations could be made hereto without departing from the spirit and scope of the invention.

What is claimed is:

1. A non-transitory computer-readable recording medium having recorded therein a component arrangement program for causing a computer to execute a process for arranging a plurality of components on a board, the process comprising:
checking, when arranging one component of the plurality of components, an interference state between a first check region set to the one component and a second check region set to an arranged component near the one component;
determining, when the interference state checked satisfies predetermined conditions, a position where the one component is arranged, while permitting the interference state; and
combining the first check region and the second check region to use a combined check region as one check region set for the one component and the arranged component.

2. The non-transitory computer-readable recording medium according to claim 1, wherein the predetermined conditions include a same permitted value, which permits the interference state, being set to a predetermined attribute for each of the first check region and the second check region, the first check region and the second check region interfering with each other, and a total value of a first attribute value related to the predetermined attribute of the one component and a second attribute value related to the predetermined attribute of the arranged component being equal to or less than the same permitted value.

3. The non-transitory computer-readable recording medium according to claim 1, wherein the predetermined conditions include a same permitted value, which permits the interference state, being set to a predetermined attribute for each of the first check region and the second check region, the first check region or the second check region and a first occupation region occupied by the one component or a second occupation region occupied by the arranged component interfering with each other, and a total value of a first attribute value related to the predetermined attribute of the one component and a second attribute value related to the predetermined attribute of the arranged component being equal to or less than the same permitted value.

4. The non-transitory computer-readable recording medium according to claim 2, wherein a plurality of check regions is set for each of the plurality of components, and
a different permitted value concerning the predetermined attribute is set for each of the plurality of check regions.

5. The non-transitory computer-readable recording medium according to claim 2, wherein the predetermined attribute is at least one of a heating value, a weight, and an electromagnetic field.

6. A method of arranging a plurality of components on a board, wherein
a computer
checks, when arranging one component of the plurality of components, an interference state between a first check region set to the one component and a second check region set to an arranged component near the one component,
determines, when the interference state checked satisfies predetermined conditions, a position where the one component is arranged, while permitting the interference state, and
combines the first check region and the second check region to use a combined check region as one check region set for the one component and the arranged component.

7. The method according to claim 6, wherein the predetermined conditions include a same permitted value, which permits the interference state, being set to a predetermined attribute for each of the first check region and the second check region, the first check region and the second check region interfering with each other, and a total value of a first attribute value related to the predetermined attribute of the one component and a second attribute value related to the predetermined attribute of the arranged component being equal to or less than the same permitted value.

8. The method according to claim 6, wherein the predetermined conditions include a same permitted value, which permits the interference state, being set to a predetermined attribute for each of the first check region and the second check region, the first check region or the second check region and a first occupation region occupied by the one component or a second occupation region occupied by the arranged component interfering with each other, and a total value of a first attribute value related to the predetermined attribute of the one component and a second attribute value related to the predetermined attribute of the arranged component being equal to or less than the same permitted value.

9. The method according to claim 7, wherein a plurality of check regions is set for each of the plurality of components, and
a different permitted value concerning the predetermined attribute is set for each of the plurality of check regions.

10. The method according to claim 7, wherein the predetermined attribute is at least one of a heating value, a weight, and an electromagnetic field.

11. An information processing apparatus that arranges a plurality of components on a board, comprising:
a processing unit; and a storage unit, wherein
the processing unit
checks, when arranging one component of the plurality of components, an interference state between a first check region set to the one component and a second check region set to an arranged component near the one component,
determines, when the interference state checked satisfies predetermined conditions, a position where the one component is arranged, while permitting the interference state, and
combines the first check region and the second check region to use a combined check region as one check region set for the one component and the arranged component.

12. The information processing apparatus according to claim 11, wherein the predetermined conditions include a same permitted value, which permits the interference state, being set to a predetermined attribute for each of the first check region and the second check region, the first check region and the second check region interfering with each other, and a total value of a first attribute value related to the predetermined attribute of the one component and a second attribute value related to the predetermined attribute of the arranged component being equal to or less than the same permitted value.

13. The information processing apparatus according to claim 11, wherein the predetermined conditions include a same permitted value, which permits the interference state, being set to a predetermined attribute for each of the first check region and the second check region, the first check region or the second check region and a first occupation region occupied by the one component or a second occupation region occupied by the arranged component interfering with each other, and a total value of a first attribute value related to the predetermined attribute of the one component and a second attribute value related to the predetermined attribute of the arranged component being equal to or less than the same permitted value.

14. The information processing apparatus according to claim 12, wherein a plurality of check regions is set for each of the plurality of components, and
a different permitted value concerning the predetermined attribute is set for each of the plurality of check regions.

15. The information processing apparatus according to claim 12, wherein the predetermined attribute is at least one of a heating value, a weight, and an electromagnetic field.
